(19) United States
(12) Patent Application Publication
(10) Pub. No.: US 2010/0017324 A1
(43) Pub. Date: Jan. 21, 2010

(54) SYSTEM AND METHOD FOR TRADING FINANCIAL ASSETS

(75) Inventors: Justin Alexander Brownhill, New York, NY (US); Nicolas Rhinelander Perkin, New Orleans, LA (US)

Correspondence Address: DICKSTEIN SHAPIRO LLP, 1633 Broadway, NEW YORK, NY, 10019, US

(73) Assignee: THE NEW ORLEANS EXCHANGE, New Orleans, LA (US)

(21) Appl. No.: 12/503,612

(22) Filed: Jul. 15, 2009

Related U.S. Application Data
(60) Provisional application No. 61/081,406, filed on Jul. 17, 2008.

(51) Int. Cl. G06Q 40/00

(52) U.S. Cl. 705/37

(57) ABSTRACT

A system and method are disclosed that enables commoditization and trading of accounts receivable. The system preferably enables companies to reduce time for outstanding invoices to be paid by providing a marketplace for cash advanced in payment of invoices. The system and method preferably establishes an account accessible to the system to receive payment from obligors. The system provides at least one of a primary market for auctioning, and a secondary market for trading of accounts receivable.

### CROSS REFERENCE TO RELATED APPLICATIONS

The present application claims the benefit of U.S. Provisional Patent Application No. 61/081,406 filed Jul. 17, 2008, entitled “System and Method for Trading Financial Assets,” which is incorporated by reference herein.

### FIELD OF THE INVENTION

The invention relates to the trading of financial assets across a centralized electronic exchange. In particular, the present invention relates to the trading of accounts receivable in an open, standardized, centralized electronic format in at least one of a primary market and a secondary market.

### BACKGROUND OF THE INVENTION

Factoring is a financial transaction whereby a business sells its accounts receivable (i.e., invoices) at a discount. Factoring is very different from a bank loan. With factoring, the emphasis is on the value of the receivables, not the selling business's credit worthiness. In addition, factoring is not a loan—it is the purchase of an asset (the receivable). Finally, a bank loan involves two parties whereas factoring involves three.

The three parties directly involved in factoring are: the seller, the debtor, and the factor (i.e., buyer). The seller is owed money (usually for work performed or goods sold) by the second party, the debtor. The seller then sells one or more invoices due from the debtor, at a discount, to the buyer (i.e. the factor) to obtain cash. Typically the debtor is notified of the transaction, and instructed to remit payment directly to the factor. Other times, the debtor repays the seller, who then remits payment to the factor.

When a company extends trade credit to a customer, the length of time between the date the invoice is due to be paid, and the date on which the customer (i.e., the debtor) actually pays can be viewed as a free loan to the debtor. A company sells some or all of its invoices to a buyer or factor at a discount to their face value. This is a factoring sale or factor financing arrangement. The transaction benefits the company (i.e., the seller) when the marginal return earned by the company through reinvesting the proceeds of the factoring sale back into its business is greater than the marginal cost associated with the factor financing arrangement.

Factors make funds available, even when banks may not do so. Factors focus largely on the credit worthiness of the debtor, who is obligated to pay the invoices for goods or services delivered by the seller. In contrast, the fundamental emphasis in a bank lending relationship is on the creditworthiness of the company, not that of its customers.

When taking into account the time to receive funding, and the cost of that financing, factoring can be used as a viable alternative source of short term financing for businesses. The factoring industry, however, has several structural limitations.

Factoring companies are generally localized and only offer their services to a select geography. Factors are often focused solely on one industry and may not finance other companies outside their industry focus. As a result factoring transactions are generally unique from transaction to transaction.

There is no standard format in which a factoring transaction is consurnmated. Each factoring transaction is highly customized and is generally distinctive from transaction to transaction. There are no standard industry practices, and no central governing authority or central information aggregator. Additionally there is no standardized process for due diligence. These limitations may inhibit a small or medium sized business from pursuing financing through a factoring transaction. The lack of standardization practices in the current factoring industry is evident by the fact that most factoring transactions are generally unique. The time and associated costs with arranging a factoring deal can be high. For small and medium sized businesses, the availability of quick access to working capital through a standardized system may be especially beneficial.

Factors can require a debtor to receive notice (i.e. notification) of a factor finance arrangement in order to assist the factor in its due diligence investigations or to expedite repayment directly to the factor. However, many companies are hesitant to reveal to their customers that they have entered into a factoring agreement to sell invoices.

Many companies would benefit from accounts receivable financing transactions, where the privacy of the transaction is maintained from the debtor

A typical factoring arrangement is where the debtor is notified to pay the factor. The factor takes on both the responsibility for collection of payments from the debtor, and the risk that the debtor will not pay due to the debtor becoming insolvent or otherwise failing to pay the invoice when due. This traditional method of factoring puts the risk of non-payment fully on the factor and is referred to as “non-recourse factoring.” Thus, if the debtor cannot pay the invoice due to insolvency or any other reason, the factor may seek recourse against the debtor but the factor cannot seek payment from the seller.

The cost to a company selling its invoices can be higher than traditional sources of short term financing with a factoring transaction. This is due to the factor assuming greater risk and providing credit checking and payment collection services as part of the overall package.

Factors will generally purchase solid credit worthy invoices and may turn away lesser credit quality companies.

Factors generally source their transactions themselves or through a broker. Brokers of transactions generally operate on a local level, and their reach can be disparate and limited in scope.

A centralized origination source for accounts receivable could benefit the factoring industry. This would allow factors and other entities interested in purchasing accounts receivable invoices to come to one location to increase the scope of their activity.

These structural limitations of factoring bring about the need for a centralized system. This centralized system could provide standardization and uniformity to accounts receivable transactions. The system could also benefit the company by providing the most efficient pricing possible by offering the financing opportunity across a system that is open to multiple potential buyers who could bid in an organized competitive fashion. Factors and other entities that purchase accounts receivable could benefit from a centralized market that allows for trade and price discovery.

When a factor executes a transaction it generally intends to hold onto the invoice through payment, or enforce collection. There is currently no organized secondary market for the trading of factored accounts receivable.

Accordingly, there is a need for a centralized system and method to standardize the process for aggregating information for transacting account receivable financing agreements.

### SUMMARY OF THE INVENTION

The invention relates to a system and method that enables trading of accounts receivable across a standardized central exchange. The system enables companies to reduce their days-sales-outstanding (DSO) which is a measure of the time it takes for the company to collect the cash due to them for goods and services provided, and documented by outstanding invoices. Companies can reduce their DSO by selling their receivables across the exchange and receiving cash a few days after the goods and services are invoiced, rather than waiting for the invoice to be paid by the debtor. The system and method provides at least one of a primary market and a secondary market for the sale and purchase of accounts receivable without alerting the debtor that its payable account has been sold.

In one embodiment, the present invention is directed to a method of selling financial assets comprising the steps of: establishing a software based, online primary auction system, having standardized procedures, registering at least one qualified seller and at least one qualified buyer, the system filing a security interest on the seller and holding the security interest as legal and collateral agent for all buyers, the seller posting a qualified financial asset of an obligor on the online primary auction system, which involves the seller establishing auction parameters that govern acceptance of bids for the auction, thereby creating an auction involving the qualified financial asset, the system assigning a repurchase date to all auctions, the system conducting an auction for the financial asset, the system awarding to a winning buyer ownership of the financial asset, the system drawing funds from the buyer and transferring them to the seller, the system performing settlement of the traded financial asset including collection of payment from the obligor on the financial asset through a custodian lock box, the system extracting fees from both seller and buyer, and providing an online secondary auction system for buyers to sell their accounts receivable.

In another embodiment, the financial assets comprise multiple obligors' accounts receivable owed to the seller and when multiple financial assets are posted, the seller may group the multiple financial assets together in the same auction.

The seller can also establish auction parameters by setting the length of the auction, inputting numeric values for the minimum advance the seller seeks to obtain from a buyer, the maximum fee the seller is willing to pay to a buyer by auctioning financial assets on the system, and an auction type the seller wishes to conduct.

### BRIEF DESCRIPTION OF THE DRAWINGS

FIG. 1 is a block diagram illustrating the system architecture of an embodiment of the present invention;

FIG. 2 is a diagram illustrating various computer-readable media;

FIG. 3 is a block diagram illustrating the parties to an accounts receivable auction;

FIGS. 4-9 are exemplary screen diagrams illustrating the data entry registration process of the seller;

FIG. 10 is a screen diagram illustrating a system dashboard through which the seller has access to the status of their auctions as well as access to other features on the system;

FIGS. 11-16 are exemplary screen diagrams presented by a system of a preferred embodiment to the buyer;

FIGS. 17-18 are screen diagrams illustrating an exemplary seller profile;

FIG. 19 is a screen diagram illustrating an exemplary debtor profile;

FIG. 20 is a screen diagram illustrating information fields for a seller to provide information on a debtor;

FIG. 21 is a screen diagram illustrating entry of invoices;

FIG. 22 is a screen diagram that shows a list viewable by the seller of uploaded invoices;

FIG. 23 is a screen diagram illustrating selection of auction length and basket type;

FIG. 24 is a screen diagram illustrating invoice selection;

FIG. 25 is a screen diagram illustrating selection of auction parameters;

FIG. 26 is a screen diagram illustrating a completed auction entry;

FIG. 27 is a screen diagram illustrating a pending auction view;

FIG. 28 is a screen diagram illustrating a buyer's view of an invoice bound to an auction;

FIGS. 29-30 are screen diagrams illustrating a live auction;

FIG. 31 is a screen diagram illustrating a seller awarded auction report;

FIG. 32 is a flowchart that illustrates a preferred remittance process;

FIG. 33 is a flowchart illustrating the multiple invoice remittance reconciliation process; and

FIG. 34 is a screen diagram illustrating a completed transaction and seller remittance report.

### DETAILED DESCRIPTION OF THE INVENTION

The present invention provides a standardized method and system to facilitate the sale and purchase of accounts receivable in a primary and a secondary market. The system and method allows businesses to transform a paper invoice into a fungible asset that can be sold and purchased electronically over a centralized exchange, in the form of an auction. Primary and secondary market auctions are conducted in real time across an electronic exchange system. The primary market allows sellers to post their accounts receivable invoices on the electronic exchange system (also called the “exchange platform”) for competitive auction to a multitude of buyers.

System servers maintain the database of information necessary to facilitate all aspects of the system process: registration, listing, bidding, awarding, funding, repayment and settlement of accounts receivable transactions.

Throughout the system process, the mechanics and timing of the flow of funds between buyers, sellers and obligors (or “debtors”) are controlled by the exchange. All funds associated with transactions that take place on the system are under the dominion of the system server, and system controlled lockboxes. Preferably, the custodian of these lockboxes is a bank.

All sellers who wish to post accounts receivable invoices on the system for auction go through a registration process. During the seller registration process, documentation, such as the seller's annual financial statements are collected and organized.

Any detailed information on the payment patterns, such as accounts receivable aging reports, that relate to a company's customers is collected if available. Additionally, third party search information is gathered from public filing sources, including such things as business entity, bankruptcy and lien searches, are collected and organized, along with corporate documentation such as articles of incorporation and bylaws are collected.

Buyers that wish to purchase accounts receivable on the system also register. Registration can include collection of articles of incorporation and accreditation confirmation.

In the preferred embodiment, sellers have the ability to post digitized accounts receivable invoices, or baskets of invoices, to the system for sale in the primary market. The system organizes all posted invoices into auctions, which are then bid on by buyers. When an invoice is posted for auction, information particular to the accounts receivable invoice—such as invoice date, invoice due date, invoice amount, and payment terms—is collected. The system then uses this information to compute a legal repurchase date that is assigned to each auction. In addition, when the seller posts accounts receivable invoices to the system and creates an auction, the seller specifies a minimum acceptable price, in the form of a minimum advance and a maximum fee that it requires all bids to meet.

Once a seller has posted an invoice or basket of invoices on the system and created an auction, the information pertinent to it is also made available to buyers. This information can include all the details of the invoice including a viewable digitized copy, as well as documentation collected about the seller during registration. The system may also make available any prior transaction history between seller and debtor, as well as any relevant credit research derived internally or obtained from third party research providers.

Buyers can search the system for auctions containing accounts receivable invoices that meet criteria particular to their investment strategy, such as, for example, seller credit rating, debtor credit rating, size of invoice, and the price of past accounts receivable transactions effected on the system. Buyers also have access to certain information to assist them in their credit review. This information may include, but is not limited to, third party search results of public filing information as well as documents collected in the registration process including a seller's financial records, articles of incorporation, and lien searches as well as proprietary credit information compiled by the system.

Buyers may purchase an auction on the system by entering a bid into a live auction. The winning buyer or buyers at the close of an auction are responsible for funding the transaction. Funding and the mechanics of all cash flows are administered by the system process.

Once a buyer has purchased an auction they may choose to hold the auction until the debtor pays or may look to resell the invoice. If the buyer wishes to hold the invoice they will go through the repayment process and the settlement process. If they wish to resell the invoice they may transact on the systems secondary market system. Auctions consisting of invoices and/or baskets of invoices are divisible in the secondary market according the desire of the holder.

System Architecture

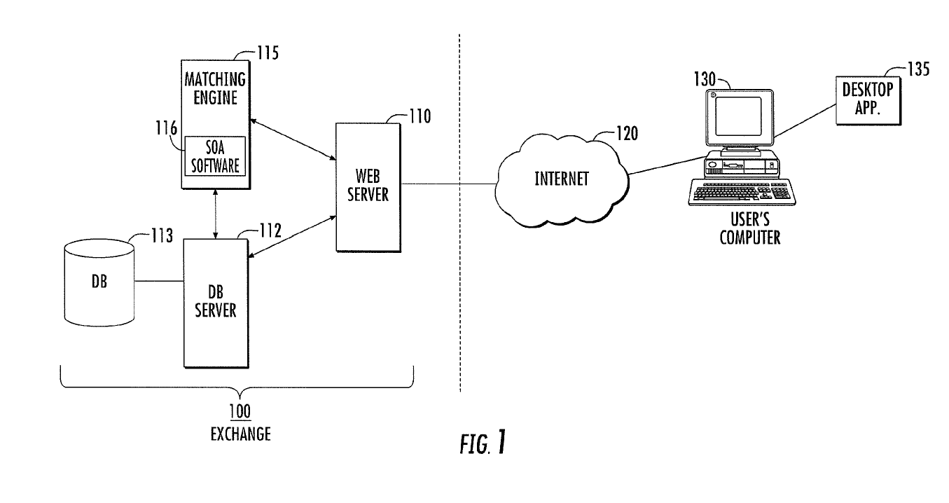

FIG. 1 is a block diagram illustrating the system architecture of an embodiment of the present invention. As shown in FIG. 1, an exchange 100 comprises a collection of data processing equipment, software and information stored in memory, wherein such data processing equipment is coupled to a network, such as the Internet 120, and uses such network 120 to communicate with one or more user computers 130. The exchange 100 preferably comprises one or more web servers 110, database servers 112, databases 113 and matching engines 115 comprising service oriented application software 116. Web servers 110 are in communication with the database servers 112 and matching engines 115.

Web servers 110, database servers 112 and matching engines 115 (collectively “system servers”) may comprise one or more computers with software that provides the various functions described below. Web servers 110 provide a convenient means of communication with, and serve as an interface to user computers 130. In a preferred embodiment, database servers 112 respond to requests to retrieve or store information from matching engines 115 and web servers 110. Matching engines 115 are servers that provide matching functions for the auctions, and make required determinations for award of the auctions.

The system servers 110, 112 and 115 are preferably configured to enable the system process to have dominion over the flow of funds between all parties that interact either directly or indirectly with the system. The system administers this process throughout the life of an accounts receivable auction transaction.

The exchange 100 further comprises a collection of programs (one or more software modules) executed on top of a service oriented architecture 116 with a cluster of computers that interface to a network (such as the Internet 120) and a client-side program 135 (such as a desktop application) which allows an end user computer 130 to access the services of the system.

The system includes one or more databases 113 from which the data used in the system is stored and retrieved. Certain of these databases 113 can be maintained by independent third parties, and accessed by the system of the present invention as described herein. It should also be noted that the present invention may employ any number of conventional techniques for data transmission, signaling, data processing, network control, and the like.

It should be appreciated that the particular implementations shown and described herein are illustrative of the invention and its best mode and are not intended to otherwise limit the scope of the present invention in any way. Indeed, for the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical or virtual couplings between the various elements. It should be noted that many alternative or additional functional relationships or physical or virtual connections may be present in a practical electronic data communications system.

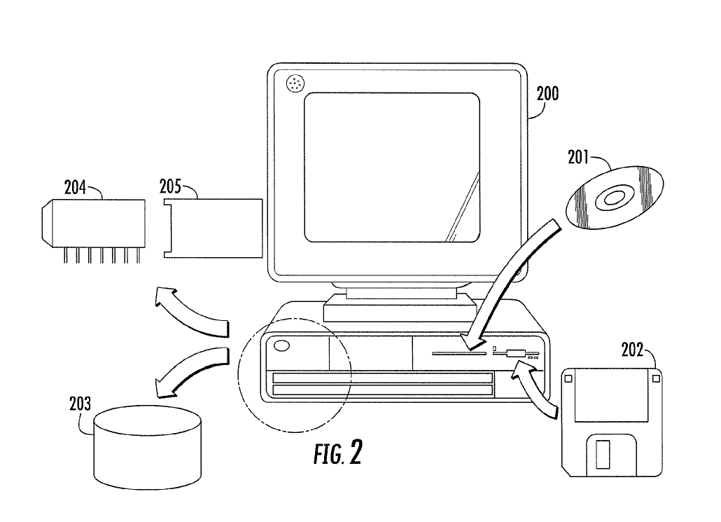

As will be appreciated by one of ordinary skill in the art, the present invention may be embodied as a method, a data processing system, a device for data processing, and/or a computer program product. Accordingly, the present invention may take the form of an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like. In the specification, the term “media” means any medium which can record data therein. Examples of a recording medium are illustrated in FIG. 2.

The term “media” includes, for instance, a disk shaped media for 201 such as CD-ROM (compact disc-read only memory), magneto optical disc or MO, digital video disc-read only memory or DVD-ROM, digital video disc-random access memory or DVD-RAM, a floppy disc 202, a memory chip 204 such as random access memory or RAM, read only memory or ROM, erasable programmable read only memory or E-PROM, electrical erasable programmable read only memory or EE-PROM, a rewriteable card-type read only memory 205 such as a smart card, a magnetic tape, a hard disc 203, and any other suitable means for storing a program therein.

A recording media storing a program for accomplishing the above mentioned apparatus maybe accomplished by programming functions of the above mentioned apparatuses with a programming language readable by a computer 200 or processor, and recording the program on a media such as mentioned above.

A server equipped with a hard disk drive may be employed as a recording media. It is also possible to accomplish the present invention by storing the above mentioned computer program on such a hard disk in a server and reading the computer program by other computers through a network.

As a computer processing device 200, any suitable device for performing computations in accordance with a computer program may be used. Examples of such devices include a personal computer, a laptop computer, a microprocessor, a programmable logic device, a field programmable gate array, a discrete signal processor or an application specific integrated circuit.

The present invention is described below with reference to block diagrams, depictions of graphical user interfaces, and flowchart illustrations of methods, apparatus (e.g., systems), and computer program products according to various aspects of the invention. It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an exchange system that implements the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems that perform the specified functions or steps, or suitable combinations of special purpose hardware and computer instructions.

One skilled in the art will also appreciate that, for security reasons, any databases, systems, or components of the present invention may consist of any combination of databases or components at a single location or at multiple locations, wherein each database or system includes any of various suitable security features, such as firewalls, access codes, encryption, de-encryption, compression, decompression, and/or the like.

A preferred embodiment of the system and method of the present invention is shown in the attached figures. The system is designed to create a centralized exchange having various markets to facilitate the auction and trade of accounts receivable invoices without some of the limitations associated with traditional factoring and other traditional business financing processes. These markets include a primary market where sellers can place their accounts receivable invoices up for auction, and a secondary market where invoices could be bought, sold and traded in an open market format, or that may be similar to the auction process that takes place in the primary market.

System Operation

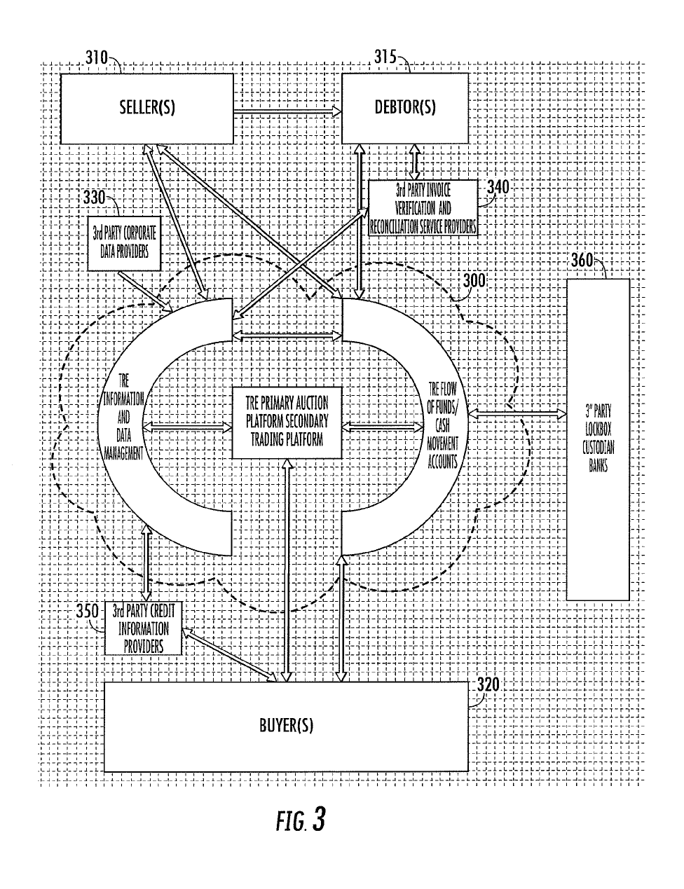

FIG. 3 is a block diagram illustrating the parties to an accounts receivable auction. As shown in FIG. 3, system 300 (identified as “The Receivables Exchange”) is designed to interact with multiple parties including sellers, debtors, third party providers, and buyers. Sellers 310 have the ability to sell accounts receivable invoices due from debtors on a primary market. Buyers 320 can bid in competitive auctions for the right to buy these invoices and earn a fee in exchange for providing an advance amount to a seller 310. System 300 also provides a standardized product in the form of an accounts receivable invoice with a standardized structure. When a buyer has a successful bid on an invoice, the buyer receives a repurchase obligation with a set enforcement date from the seller, and will have a perfected security on the invoice. The system standardizes the registration, listing, and bidding processes, the awarding process once the primary market auctions are closed, the funding, repayment and settlement processes, the mechanics of the flow of funds, as well as the documentation provided that supports all of these actions.

Participants

The following are the main participants of the present invention (FIG. 3):

Sellers 310: Sellers are any entity that lists their accounts receivable for bid on the system. Sellers can be the originator of accounts receivable for sale through the system's primary market, or can be other types of entities that have purchased accounts receivable and wish to monetize them through the system's secondary market.

Debtors 315: Debtors are obligors under the terms of an accounts receivable invoice. They provide payment for the goods or services they receive from sellers at some specified time interval as detailed in the terms on an invoice.

Buyers 320: An investor approved to trade on the system. Buyers have the ability to enter offers to purchase accounts receivable in a primary market, and become buyers who can further transact on a secondary market.

Third Party Corporate Data Providers 330: These entities provide data about participants in the system, such as public filing information on the sellers, including but not limited to credit information, operating history, UCC lien searches and bankruptcy information.

Third Party Invoice Verification and Reconciliation Service Providers 340: These entities verify the validity and accuracy of invoices that a seller posts to the system.

Third Party Credit Information Providers 350: These companies provide research that may augment the due diligence process of the buyers as they evaluate invoices or baskets of invoices for purchase on the primary or secondary market.

Third Party Lockbox Custodian Banks 360: These entities provide for the administration over the flow of funds between participants on the exchange.

The Exchange 300: The system that controls information and data management, fund flow and cash movement accounts, as well as the primary and secondary market auction systems. The exchange has the functionality to perform all steps of the system process: registration, listing, bidding, awarding, funding, repayment and settlement that takes place over the life of an accounts receivable transaction.

Step 1: Registration

Seller Registration/Approval

Prospective sellers preferably meet and maintain certain minimum quantitative standards in order to be approved and remain registered for trading on the system. These minimum standards are designed to render good corporate standing and to maintain a certain standard of quality and size of the seller companies. For example, at a minimum quantitative standard for a seller is to have an annual revenue for the preceding twelve months of $1.5M, and an operating history of at least 24 months prior to registration on the exchange, and are registered to do business in the United States.

During the registration process, a seller provides certain basic information and registration documentation to the system as required by system registration tabs. The basic information includes, but is not limited to, business information, contact information, banking information, credit information and financial information. The seller provides the required documentation by uploading electronic formatted documents as required by the system. Additional financial statements required by the system include income statements, cash flow statements, and balance sheets and reconciliation of capital account statements. Preferably, such statements are audited or reviewed by a Certified Public Accountant. In addition, in the preferred embodiment, the seller provides the previous two annual tax filings, amended if necessary. Additional information required of the seller includes aging reports for accounts receivable, and more preferably a detailed report by invoice date, accounts payable aging, certificate of incorporation or equivalent, operating agreements or equivalent, certificate of good standing or equivalent, any regulatory or government authorization to do business, and blank corporate letterhead in an editable format.

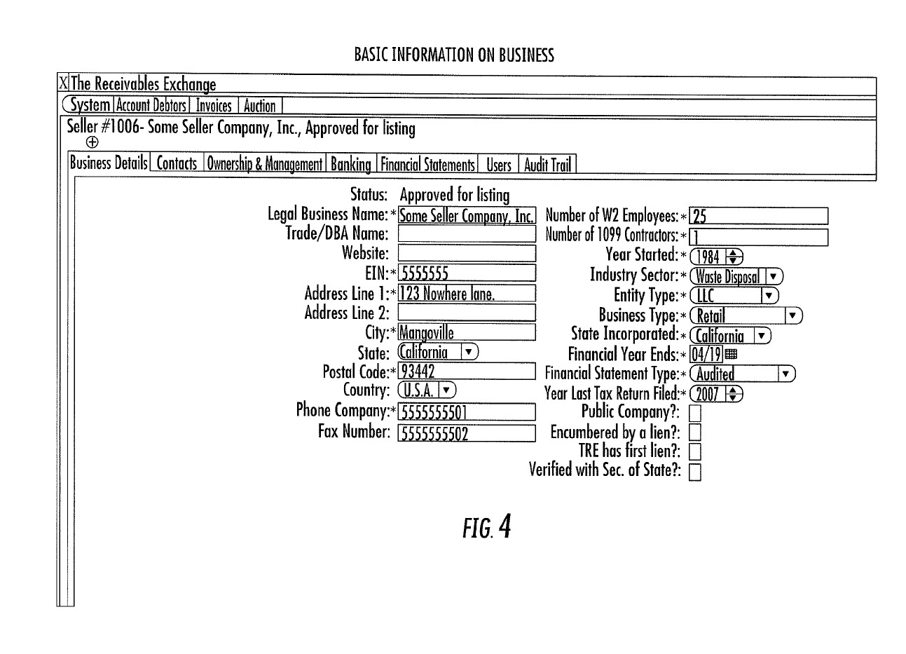

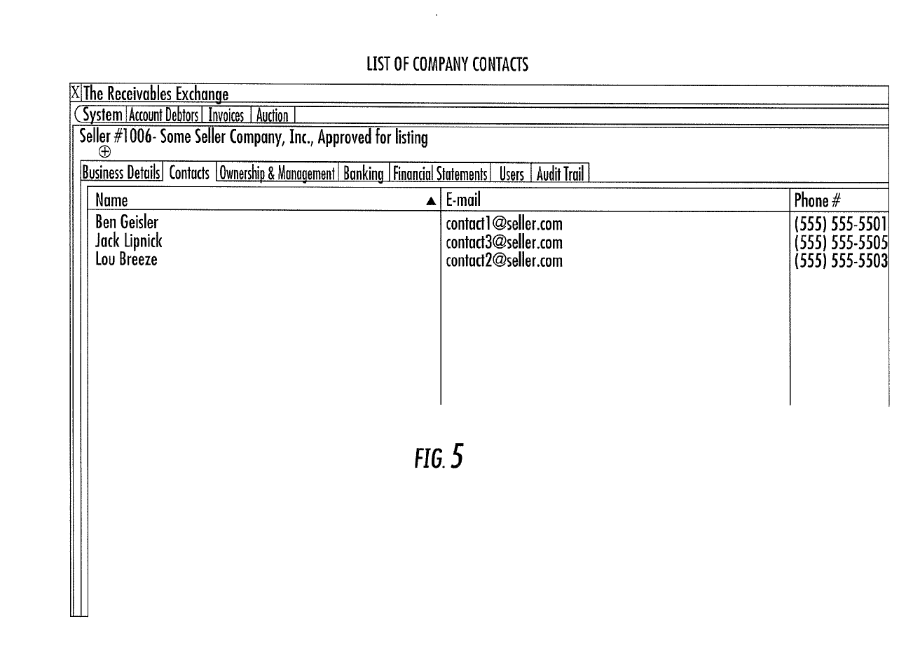

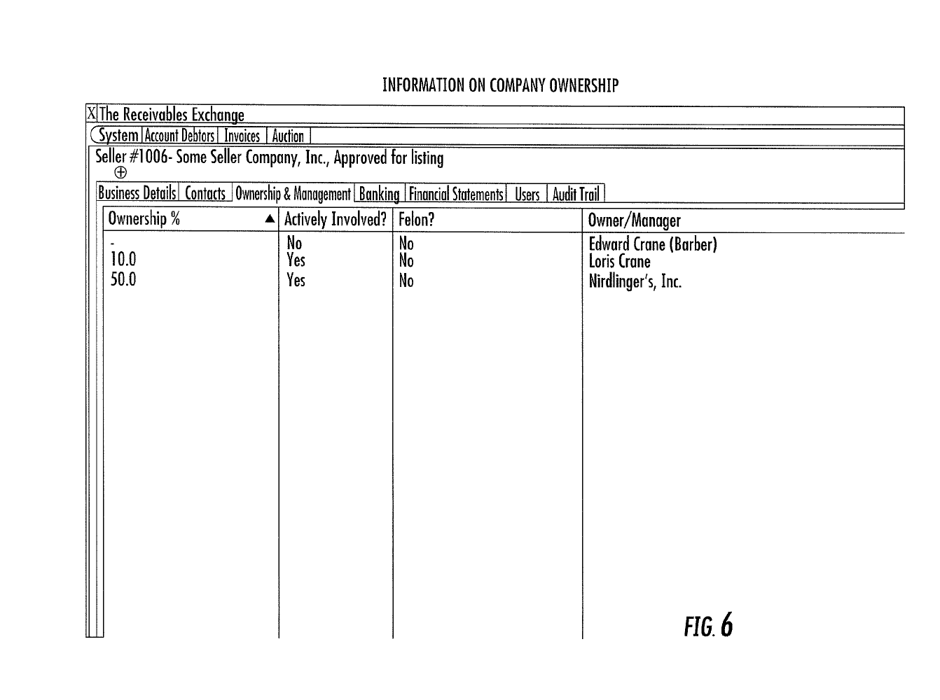

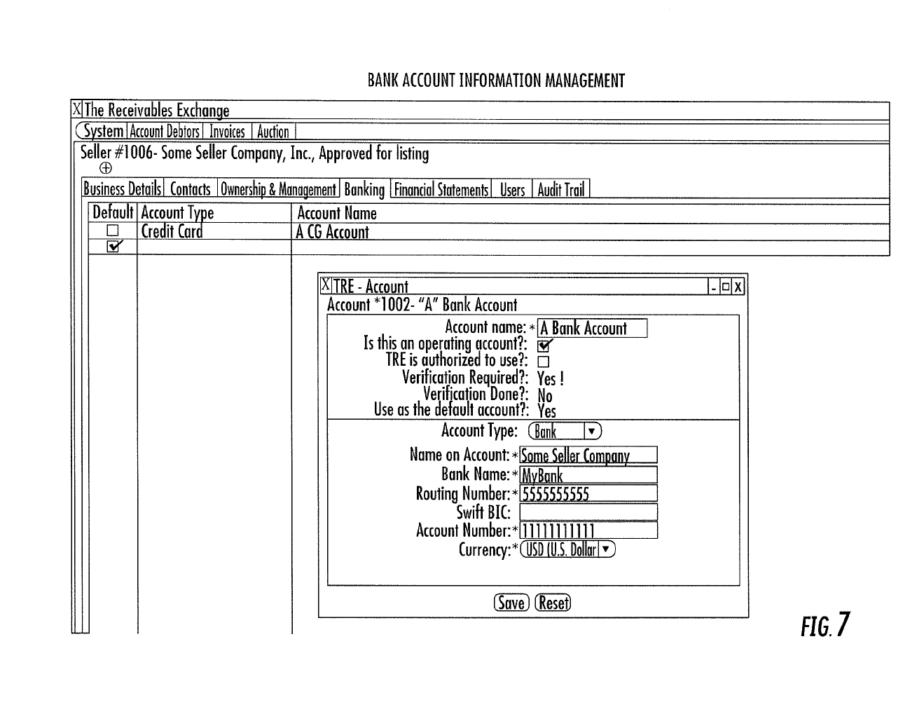

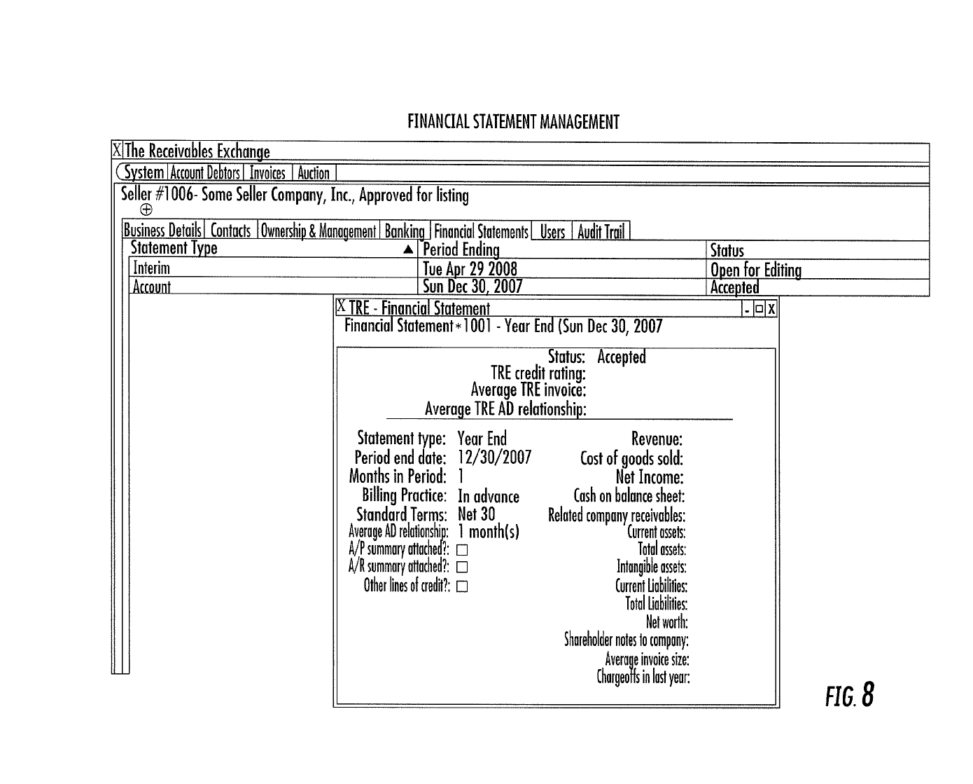

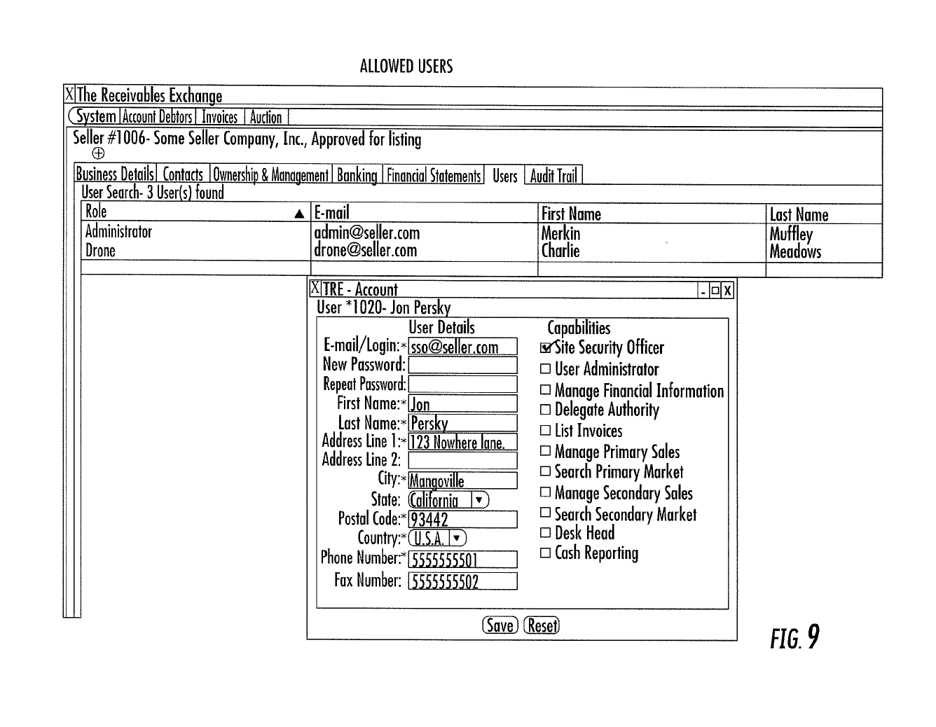

During the registration process, the seller is preferably presented with an interface that includes fields requiring the input of certain business information, contact and ownership information, banking information, credit and financial information. FIGS. 4-9 are screen diagrams illustrating an exemplary data entry registration process. Preferably, the seller identifies an industry sector from a list such as the North American Industry Classification System (http://www.census.gov/eos/www/naics/). Such sector identification, among other criteria, will allow buyers to readily identify the diversity of their particular invoice purchases, as described in further detail below. The seller also uploads certain required documentation to the system in support of their approval, such as bank and tax statements, financial statements, etc.

Upon completion of registration submission and legal consents, the exchange tests whether the seller meets the minimum quantitative standards, and if so, performs a background check against seller's corporate and individual records. Such searches may include, but are not limited to, searching criminal records, OFAC, a Patriot Act search, a tax lien search, and bankruptcy records.

Next, the exchange completes its full registration processing of the seller. When the registration results are satisfactory to the exchange, the seller is approved. The exchange will file a UCC1 financing statement and conducts a search to reflect this filing position. By filing the UCC1 statement in the name of the exchange, and by having all sellers and buyers sign a legal master program agreement, the exchange system is designed to act as legal and collateral agent for all sellers and buyers.

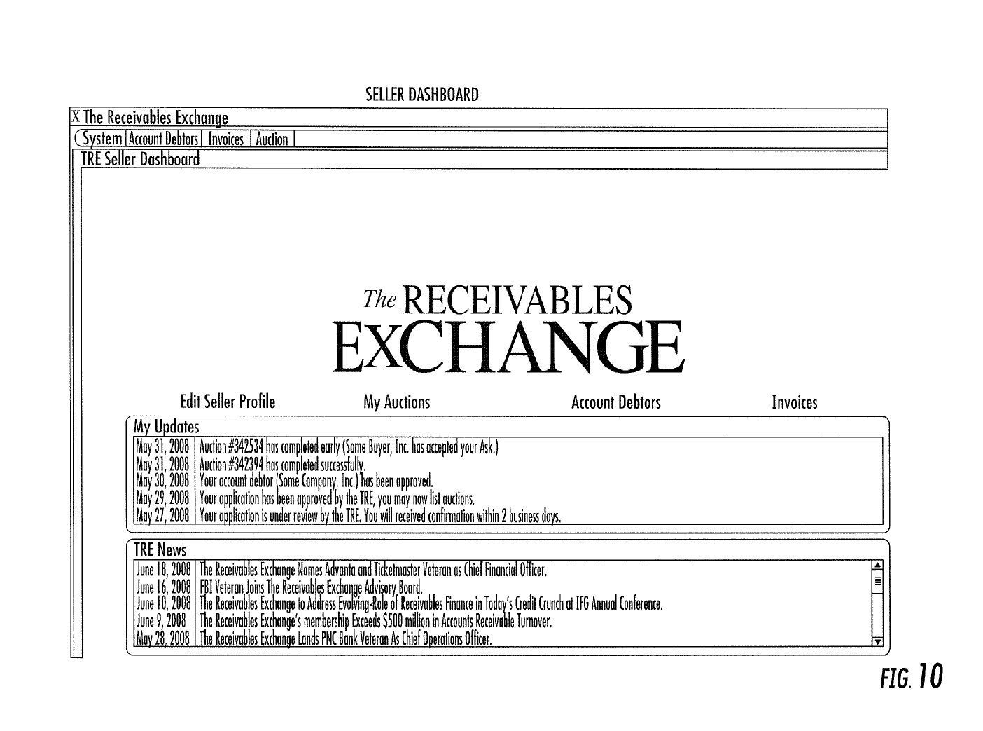

FIG. 10 is a screen diagram illustrating a system dashboard through which the seller has access to the status of their auctions as well as access to other features on the system. Once the seller is approved, it can then upload a list of debtors and post invoices for auction. The uploading of this information can be from an electronic format and saved into the system database.

To maintain a good standing registered status, a seller is preferably required to verify their qualifications at the end of each fiscal quarter. For example, all registered sellers are required to upload to the exchange the previous year-end unaudited financial statements of seller and its subsidiaries, if any, on a consolidated basis, consisting of balance sheets and statements of income and retained earnings and cash flow, setting forth in comparative form in each case the figures for the prior fiscal year.

Buyer Registration/Approval

Prospective buyers preferably meet and maintain certain minimum quantitative standards in order to be approved and remain registered for trading on the system. These minimum standards are designed to render good corporate standing and to maintain a certain standard of quality and size of the buyer companies. These buyers can be divided into different levels of participation depending on their size and structure. Conditions which might determine what level a buyer participates in can include capital base, monthly bidding requirements, and other factors as well.

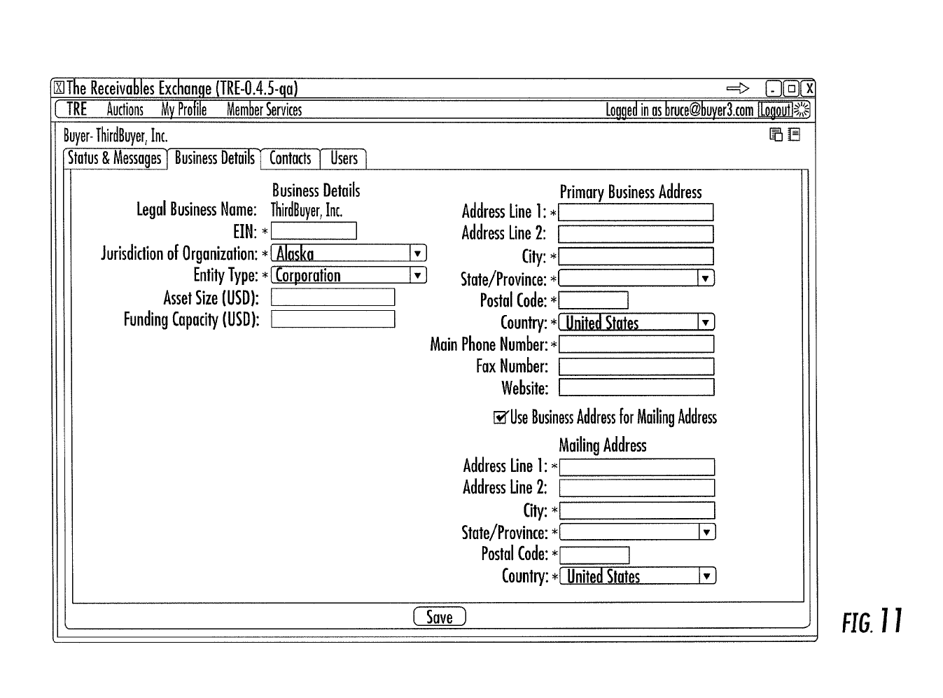

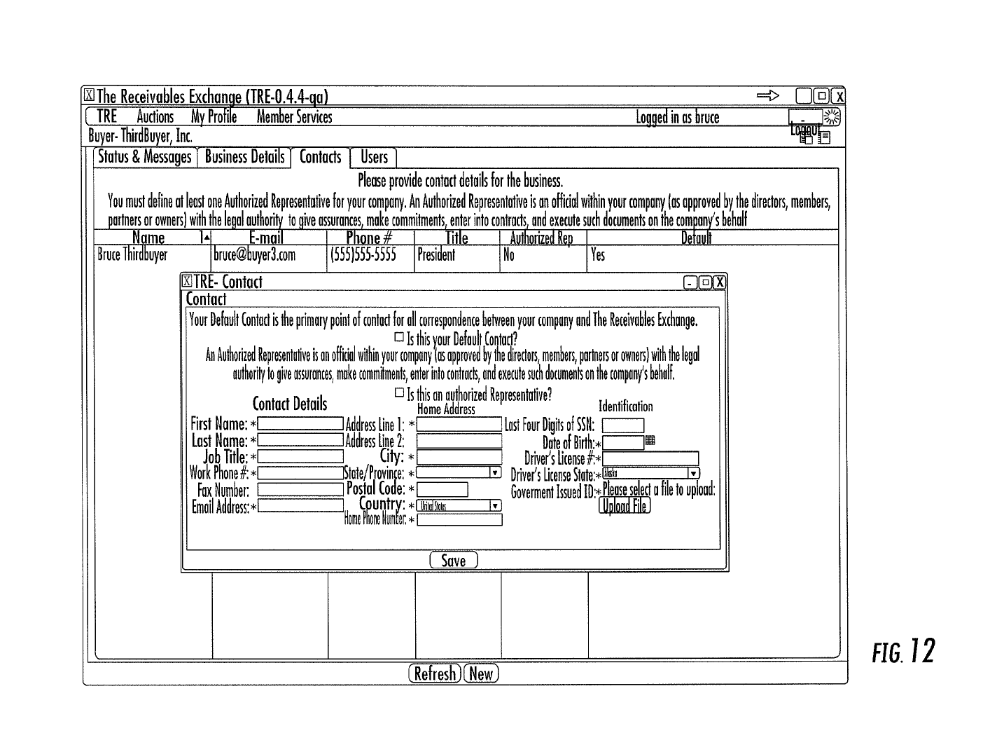

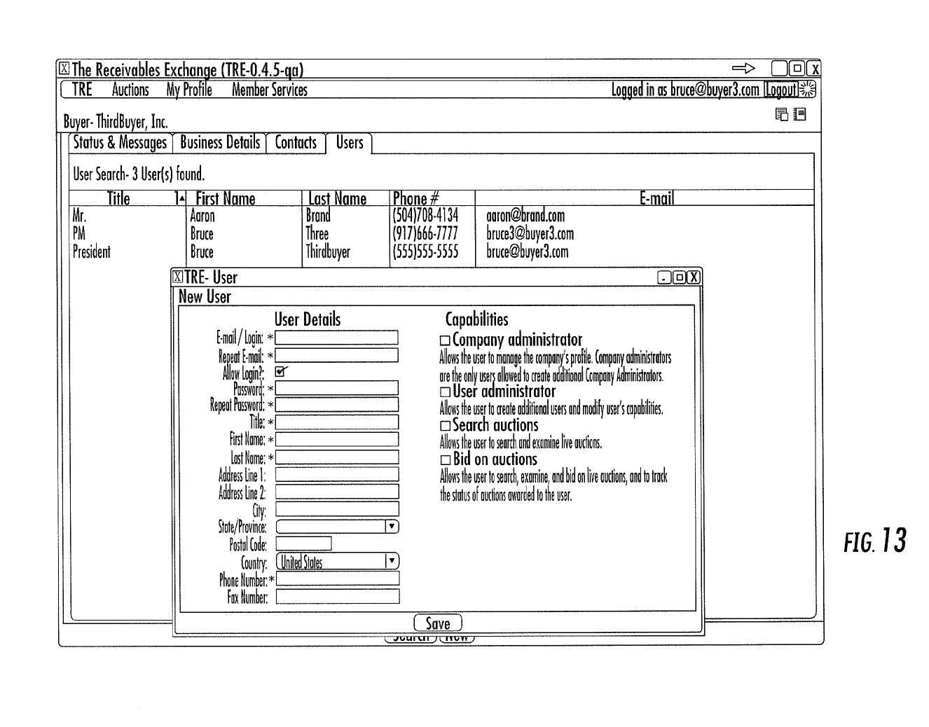

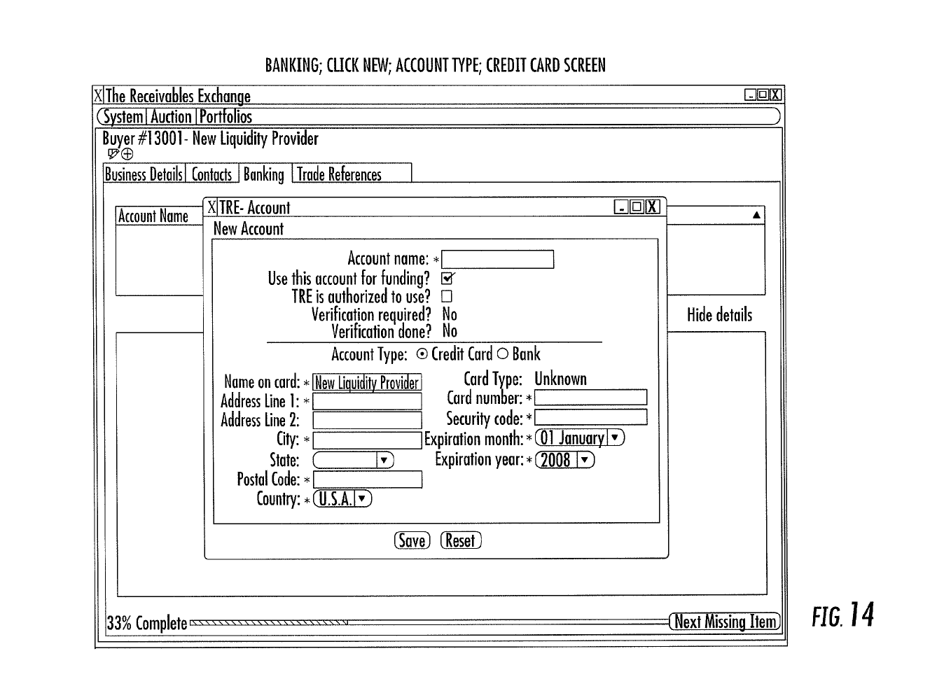

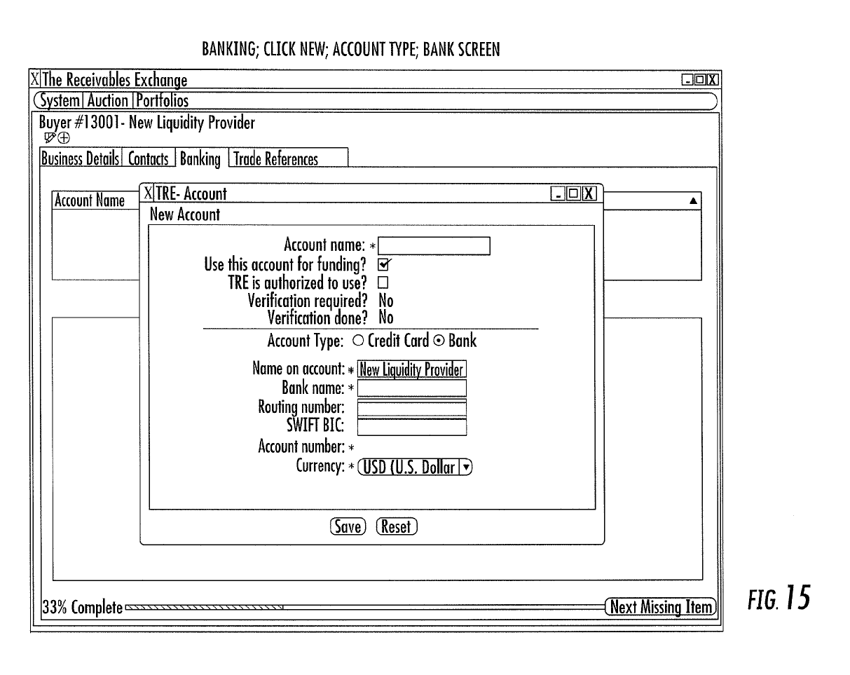

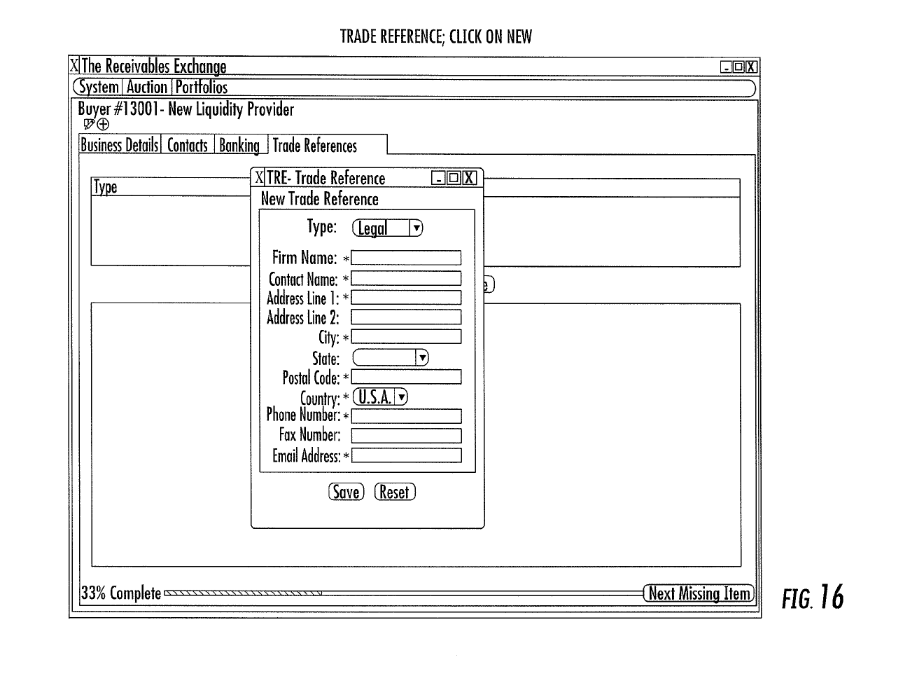

During the registration process a buyer provides certain information and registration documentation to the system. FIGS. 11-16 are exemplary screen diagrams presented by a system of a preferred embodiment to the buyer. The screen diagrams presented include fields requiring the input of certain business information, contact information, banking information, reference information and financial information.

The buyer is also presented with and enters into a legal commitment outlining the terms of use of the system.

Buyer Due Diligence

Buyers have the opportunity to perform due diligence on both the seller and the debtor when deciding whether to bid on a particular auction posted for sale on the exchange. All decisions to bid on actions and the amounts of such bids are solely within the buyer's discretion and independent business judgment. The exchange has contractual limitations on its responsibility and liability with respect to buyers.

Buyer Access to Seller Information

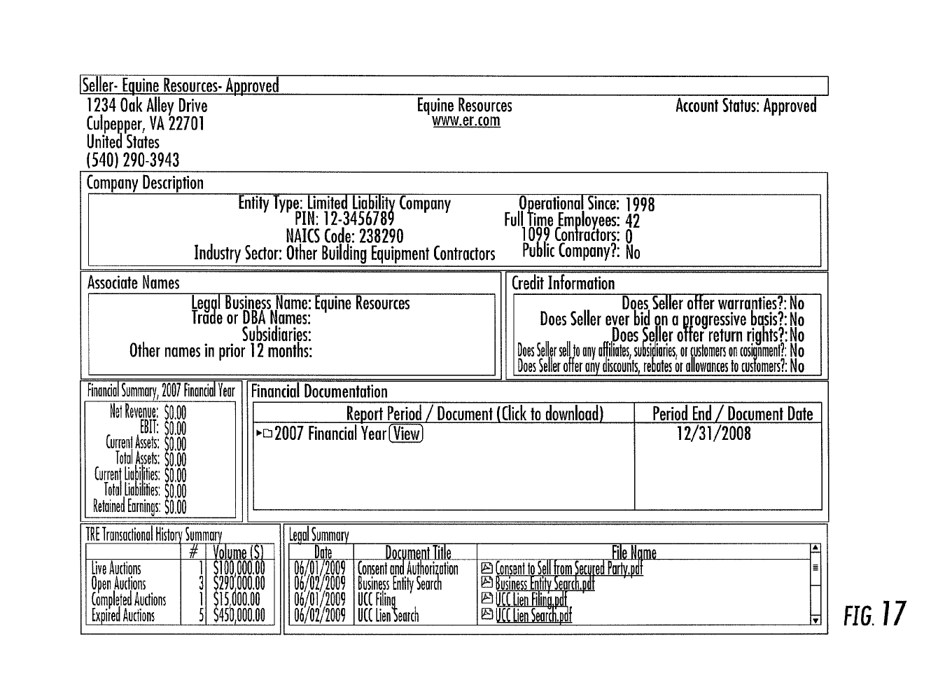

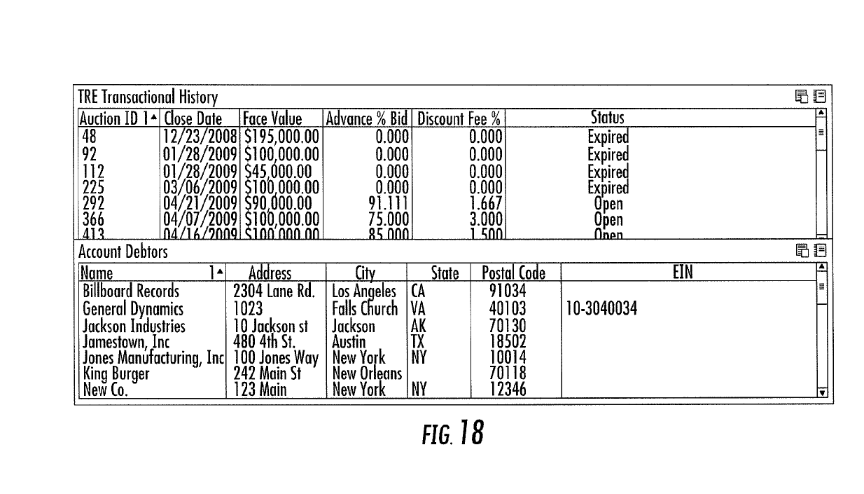

Buyers may access seller information and the exchange's work product data available on the system to evaluate whether to bid on auctions posted for sale on the exchange. In a preferred embodiment, seller information provided to buyers includes: basic business information on the seller such as legal business name, entity type, EIN number, NAICS code, industry sector, years operational, DBA names, subsidiaries, prior company names and number of employees; billing practices such as terms and discounts provided if any; historical financial statements plus supplemental financial information; the seller's historical transactional auction history by dollar volume, units and status; historical payment patterns of the seller's debtors; a legal summary, including UCC lien searches, UCC filings, business entity searches, consent and authorizations (if applicable), change of remittance address and notification letters (if applicable); a copy of the original underlying documentation of the posted receivable, and any supporting documentation (such as debtor payment history, purchase orders, bill of lading) supplied by the seller. This is shown in FIGS. 17-18.

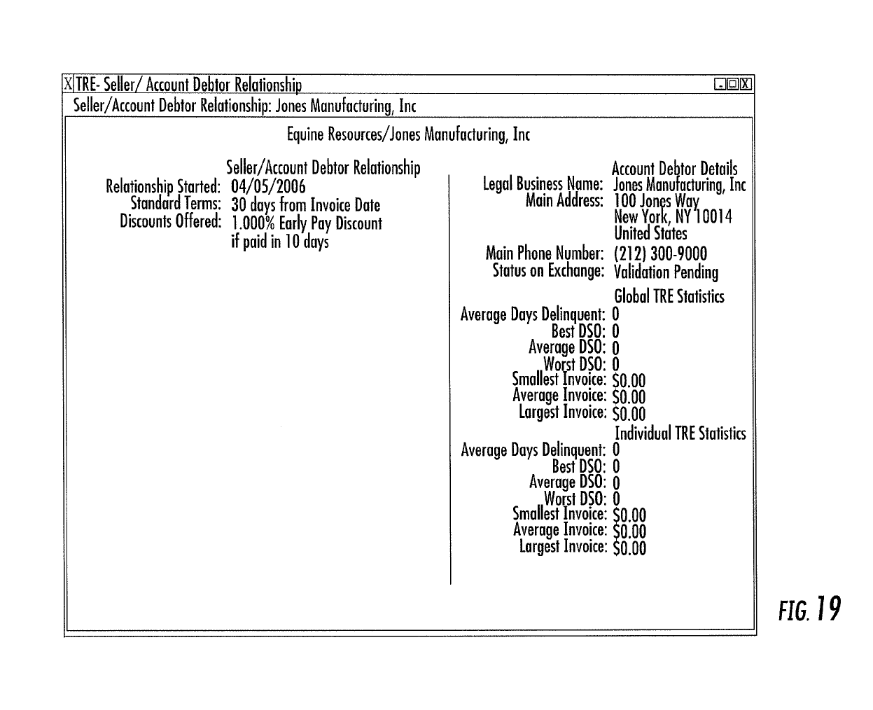

Buyers may also see access to the historical payment history between the seller and their debtors. This view will show the payment trends between the seller and debtor, as well as showing the payment trends of that debtor across all other sellers that may sell receivables from that debtor on the exchange. This is shown in FIG. 19.

Step 2: Listing

Entry of Debtor Information

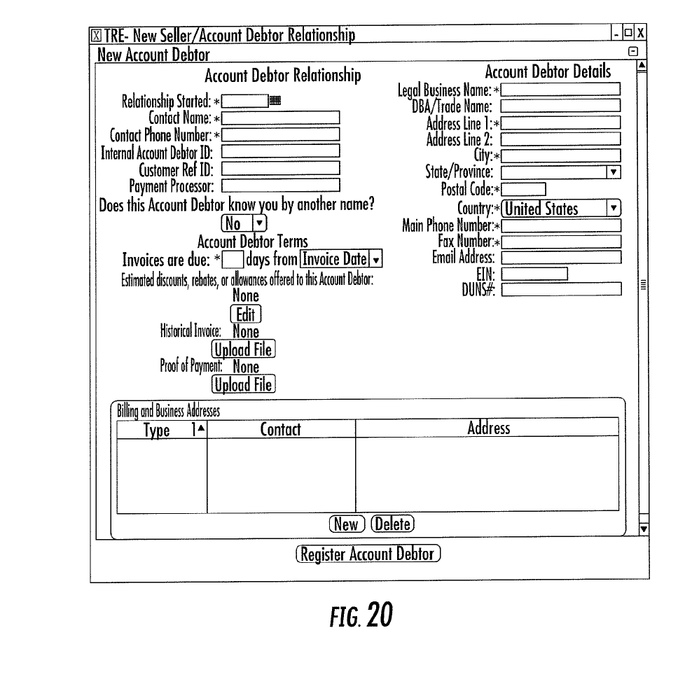

FIG. 20 is a screen diagram illustrating information fields completed by a seller on a debtor they intend to sell accounts receivable from. In the preferred embodiment, the seller provides or confirms the following information when registering a debtor on the exchange: the debtor's legal business name and any trade or DBA name(s); the debtor's main business address, telephone, fax numbers and email address; the name and business telephone number of the debtor's accounts payable contact person (optional); the debtor's EIN or DUNS number (optional); the date the seller's relationship with the debtor began; the customer reference ID number that the debtor may assign to the seller (optional); the other names (such as the seller's DBA name) that the debtor may use to identify the seller; the payment terms that exist between the seller and the debtor including the time period in which remittances are due and any agreed upon discounts, allowances and rebates; and a historical invoice with its respective proof of payment between the seller and the debtor (optional).

The exchange is configured to accept or reject a seller's request to register one or more particular debtors on the exchange. The exchange may attempt to verify that the debtor validly exists as a business entity and that the debtor has a business relationship with the seller.

When a seller enters information about a debtor, the system may use a third party service provider to authenticate the debtor, or may authenticate internally. In particular, the system seeks validation of business name, address and good standing from a third party provider. A comprehensive business report, including name variations and business at address is reviewed to check discrepancies. In addition, a Patriot Act batch report is sought of each debtor. The system is designed to preempt any attempts at misrepresentation or fraud by sellers by first validating the legitimacy of the business through the registration documents, and then by verifying the validity and accuracy of any and all invoices that are posted to the exchange by a seller for auction. The system is designed such that this is carried out through verification of documents and invoices either by a person via telephone or letter, or utilizing various electronic verification methods.

Removing Debtors

A seller may request to remove a registered debtor from the exchange only when the seller's outstanding balances for that debtor's traded receivables have been satisfied. If approved, the exchange will send a notice or instruction to the debtor.

Ineligible Debtors

Accounts receivable owed by certain types of debtors are ineligible to be traded over the exchange, including accounts receivable owed by: the seller's parent company or its subsidiaries or affiliates; and debtors who are in bankruptcy, insolvent or not able to pay their debts when due at time of posting; and debtors whose payables are subject to special protective statutes such as the Perishable Agricultural Commodities Act (PACA).

Redirection of Debtor Remittance Funds

Once the seller registers a debtor on the exchange, the exchange will use one of the following three options according to the seller's preference to direct the debtor to make its payments to the seller at the lockbox account address. The new lockbox account address is held under the custodianship of a bank.

Option 1: Anonymous Change of Address

In the preferred embodiment, the seller will elect to have the exchange redirect its payments using the Anonymous Change of Address process. The exchange will fax a new remittance address notice to the debtor on the seller's behalf. This notice will be on the seller's letterhead and contain the seller's signature.

The new remittance address notice will not identify that it is being sent by the exchange and will not advise the debtor that its payment obligations may have been sold to a buyer over the exchange.

The exchange preferably receives a signed, verbal, or electronic confirmation that the new remittance address notice has been processed prior to successfully registering that debtor on the exchange.

Once a debtor is registered on the exchange, the seller is requested to change the invoice instructions on all future invoices, to direct the debtor to make its remittance payment to the new lockbox account address. The exchange then receives an indication that the debtor has been properly instructed to make its payments to the lockbox account address before the seller will be permitted to post receivables for sale over the exchange.

Option 2: Notification of Sale of Receivables

Under this method of redirected funds, the exchange will notify the debtor that the seller will be selling its accounts receivable over the exchange and instruct the debtor to make all future remittance payments to the new lockbox account address.

Prior to sending a Notification of Sale of Receivables form to the debtor, the seller must sign a separate agreement permitting the exchange to notify the debtors of the sale of accounts receivable over the exchange

The exchange must receive a signed confirmation that the Notification of Sale of Receivables form has been processed prior to successfully registering that debtor on the exchange.

Once a debtor is registered on the exchange, the seller is required to change all future invoice instructions to direct the debtor to make its remittance payments to the new lockbox account address.

Option 3: Notification of Sale of Selected Receivables

If the seller elects to redirect its payments using the Notification of Sale of Selected Receivables form, The exchange will notify the debtor that the seller will be selling its accounts receivable over the exchange and instruct the debtor to make selected future remittance payments to the lockbox account address.

Prior to sending the Notification of Sale of Selected Receivables form to the debtor, the seller must sign a separate agreement permitting the exchange to notify the debtors of the sale of accounts receivable over the exchange.

The exchange must receive a signed confirmation that the Notification of Sale of Selected Receivables has been processed prior to successfully registering that debtor on the exchange.

The Seller Invoice Posting Process

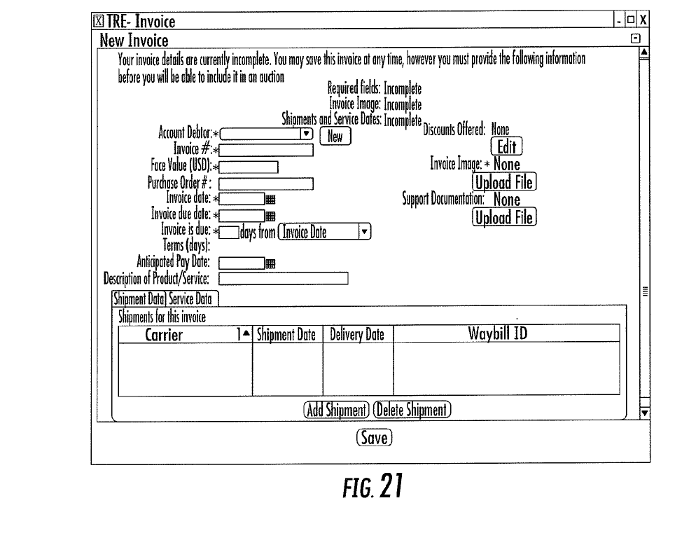

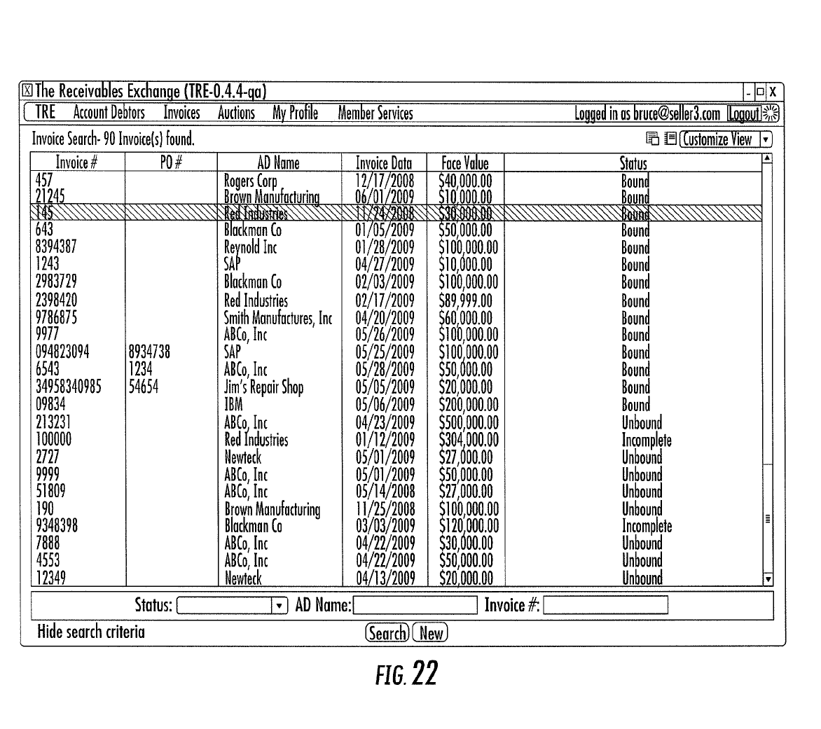

FIG. 21 is a screen diagram illustrating entry of invoices. The seller selects a debtor from the customer list entered above, and completes entry of invoicing data. Such information includes invoice amount, invoice number, invoice date, purchase order or reference number, tracking number from shipping service company, anticipated payment date, and whether there has been any change in payment history since the initial customer list was uploaded. The seller is also required to upload an electronically viewable copy of the actual invoice as generated by their internal account system. The seller is encouraged to also upload supporting documentation for the invoice. Supporting documentation can take the form or a copy of the purchase order, a bill of lading, historical payment history between the seller and debtor, or another for or evidence that supports the validity of the invoice being uploaded. The seller also inputs the shipment or service dates associated with the invoice being uploaded. Once the seller has input all the required fields, the invoice image, and the shipment or service dates and the saved the information, the invoice will be considered unbound. An unbound invoice is available to be bound into an auction. FIG. 22 is a screen diagram that shows a list viewable by the seller of all the invoices that have been uploaded into the system and status of such invoices. Unbound invoices may passively reside on the system. The system is designed to transform unbound invoices and bind them in tradable auctions.

Receivable Eligibility

Only qualifying accounts receivable may be posted for sale on the exchange. Preferably, no posted accounts receivable may be payable over a term (counted from the invoice date) of longer than 90 days. It is also preferred that auctions have a certain total minimum face value (e.g., $10,000 or more) and can be composed of an individual receivable or a “basket” of multiple receivables.

Qualifying Receivables

A qualifying receivable is an account or payment intangible subject to sale under Article 9 of the Uniform Commercial Code (UCC) that: represents a bona fide payment obligation of an eligible debtor for payment of goods sold and delivered or for services rendered and performed; and is not subject to dispute, compromise, reduction, cancellation, refund, offset, counterclaim or recoup for any reason; and the seller knows of no reason why the debtor will not or cannot pay the receivable on a timely basis when due; and is payable to and is owned by the seller; and is payable in U.S. dollars; and is no more than 60 days past due as of the auction closing date; and conforms to other requirements of the exchange to be considered a qualifying receivable eligible to be posted for sale on the exchange.

In a preferred embodiment, the exchange is configured to reject any receivable posted for sale over the exchange that is non-qualifying.

Creating An Auction

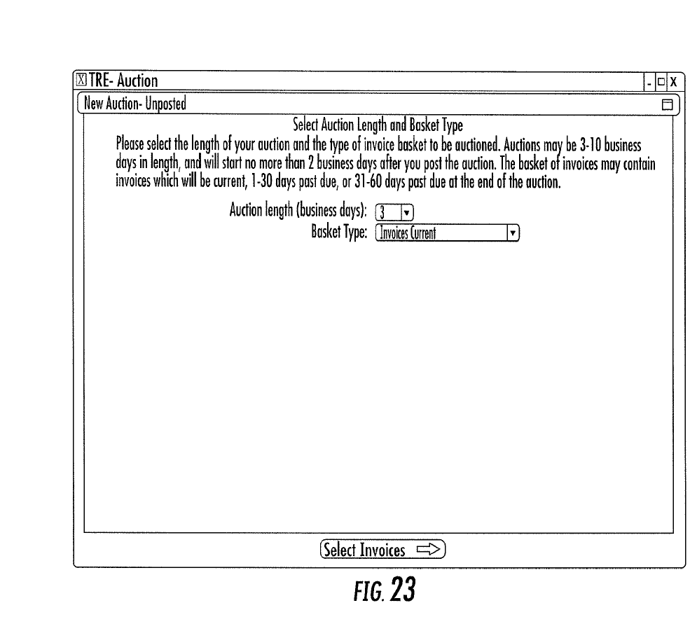

FIG. 23 is a screen diagram illustrating selection of auction length and basket type.

Auction Length

A seller can set the length of time an auction is to remain open at between 3 and 10 auction days. An auction day is the minimum 24 hour period ending at 3 p.m. ET the next subsequent business day. Before an auction is released for bid, all invoices in an auction are subject to verification. Auction days begin after verification is complete. Absent a buyer bidding the buyout price or cancellation of the auction, auctions will last the length of the term specified by the seller, regardless of the time needed to verify.

Basket Type

Accounts receivable are grouped by their proximity to their individual due dates as of the day that the auction is scheduled to close (the auction closing date). A seller can select the basket type and the system will parse all unbound invoices in its database from the seller that are available to be placed into an auction. A seller may only select invoices from one basket type for each individual auction. The system will not allow invoices from multiple basket types to be bound to the same auction. Baskets are organized into three different categories:

Current: accounts receivable that are not past due as of the auction closing date.

1-30 Days Past Due: accounts receivable in this category are 1 to 30 days past due as of the Auction Closing Date.

31-60 Days Past Due: accounts receivable in this category are 31 to 60 days past due as of the Auction Closing Date.

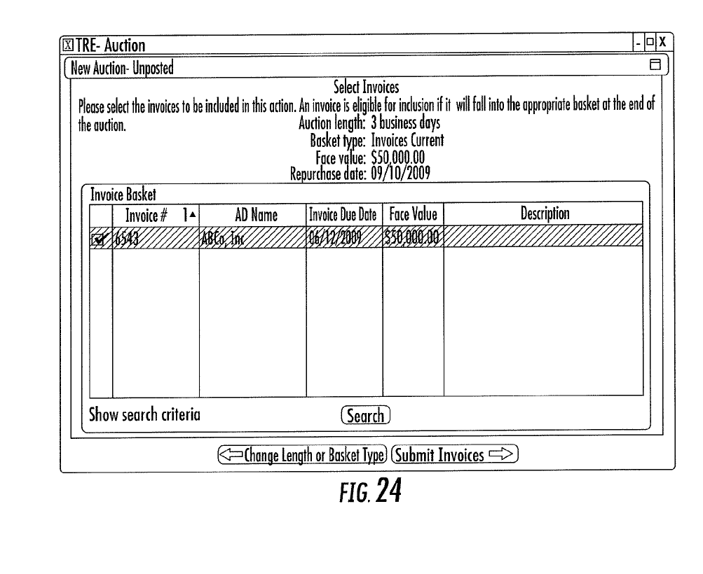

Once a seller has selected and auction length and basket type, the system parses all available unbound invoices that correspond to the basket type selected and displays them as shown in FIG. 24. The seller selects which invoices they wish to bind into their auction.

Determination of the Repurchase Date

Every auction on the exchange has a predetermined repurchase date on which the seller, under the circumstances that the debtor has not paid by such date, is absolutely obligated to repurchase the unpaid portion of the traded receivable plus all accrued discount fees. The repurchase date for an auction composed of a single individual receivable is 90 calendar days after the invoice due date. In the event the repurchase date falls on a banking holiday or weekend, the repurchase date will default to the following business day.

The formula for determining the repurchase date for auctions containing a basket of receivables is the latest in time invoice due date of any receivable in the basket, plus 90 days.

The minimum time period for any auction between the auction closing date and the repurchase date is 10 business days. The exchange system will reject a posting that does not comply with this requirement.

The repurchase date is calculated once a seller has selected the invoices they wish to bind to an auction as shown in FIG. 24. The repurchase date is calculated and displayed based on the above rules.

Setting Auction Parameters

When posting an accounts receivable for sale on the exchange, the seller has the option of selecting between three alternative methods of ranking buyer bids: (1) the Highest Net Present Value (or NPV) Wins Method, (2) the Highest Advance Amount Wins Method, and (3) the Lowest 30-Day Discount Fee Wins Method.

Auction Type: The Highest NPV Wins Method

If the seller selects the Highest NPV Wins Method of ranking competitive bids, the exchange will rank submitted bids in descending order according to their NPV as calculated by the exchange. The exchange calculates the NPV by determining the sum of two values: (i) the advance amount bid by the buyer, and (ii) the present value of the seller remittance payment (which is the retained amount, minus the 30-day discount fee).

The exchange expresses the NPV dollar value in the form of a standard percentage so that bids to purchase a proportional (less that a 100%) undivided interest in the posted accounts receivable may be ranked in comparison to other competing bids to purchase 100% of the auction. The bid(s) with the highest NPV at the time the auction closes will be declared the winning bid(s). If there is a tie, the first in time tied bid wins.

Auction Type: The Highest Advance Amount Wins Method

If the seller selects the Highest Advance Amount Wins Method of ranking competitive bids, the exchange will rank submitted bids in descending order starting with the bid with the highest bid advance rate (within the seller's Minimum Advance Amount/Maximum Discount Fee restrictions). The bid(s) with the highest advance rate at the time the auction closes will be declared the winning bid(s). If there is a tie, the first-in-time tied bid wins.

Auction Type: The Lowest 30-Day Discount Fee Wins Method

If the seller selects the Lowest 30-Day Discount Fee Wins method of ranking competitive bids, the exchange will rank submitted bids in ascending order starting with the lowest bid 30-Day discount fee rate (within the seller's Minimum Advance Amount restrictions). The bid(s) with the lowest 30-day discount fee rate at the time the auction closes will be declared the winning bid(s). If there is a tie, the first-in-time tied bid wins.

Specification of Minimum Advance Amount and Maximum Discount Fee

At the time of posting an accounts receivable or basket of receivables for sale, the seller is asked to specify the Minimum Advance Amount that the seller is willing to accept from the buyer and the Maximum Discount Fee that the seller is willing to pay over each 30-day period following the auction closing date. The seller additionally has the option to create a “buyout” advance amount and discount fee, which if bid by a single buyer, will immediately award the auction and close all further bidding.

Minimum Advance Amount

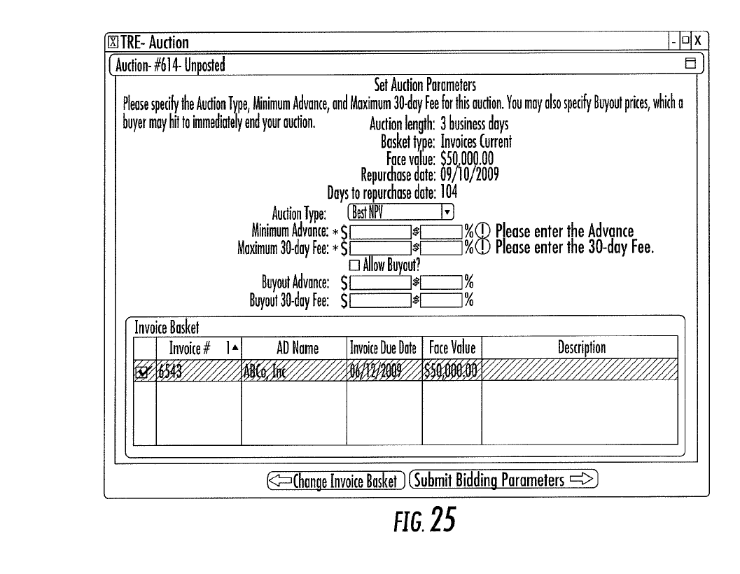

The Minimum Advance Amount is set by the seller during the posting process. The Minimum Advance Amount is the percentage of the face value of the accounts receivable or basket of receivables that the seller is willing to accept from the buyer in consideration for the sale. For example, the seller specifies a Minimum Advance Amount of $70,000.00 corresponding to a 70.000% advance rate (assuming a $100,000.00 face value), meaning that the seller has pre-specified at the time of posting that it will only accept bids with advance amounts of 70.000% or greater. This entry field is evidenced on FIG. 25.

Maximum 30-Day Discount Fee

The discount fee is based on the amount of money earned by the buyer every 30 days after the auction closing date. The buyer earns discount fees on a daily basis for each day that the traded accounts receivable remains unpaid after the auction closing date or until such time when the advance amount and all accrued discount fees have been repaid. For example, the seller specifies that it is willing to pay a Maximum Discount Fee of $3,000.00 (or 3.000% of $100,000.00 face value) every 30 days. This entry field is evidenced on FIG. 25.

Auction Parameter Rejection

The exchange system may reject seller specifications of Minimum Advance Amounts and Maximum Discount Fees that do not fit within the parameters built into the exchange application. Specifically, the program will reject any combination of Minimum Advance Amount and Maximum Discount Fee that results in a retained amount (or un-advanced portion of the receivable face value) insufficient to fully cover daily discount fees through the repurchase date.

Buyout Price Option

The seller has the option to specify what is known as a “Buyout Price,” which if bid by a single buyer, will result in the instantaneous awarding of the entire auction, thereby closing all further bidding. If a buyer were to submit a bid for 100% of the notional amount with an advance amount equal to or greater than the Buyout Advance Amount, and a discount fee equal to or less than the Buyout Discount Fee, the auction will close immediately and the buyer declared the sole winning buyer. This entry field is evidenced on FIG. 25.

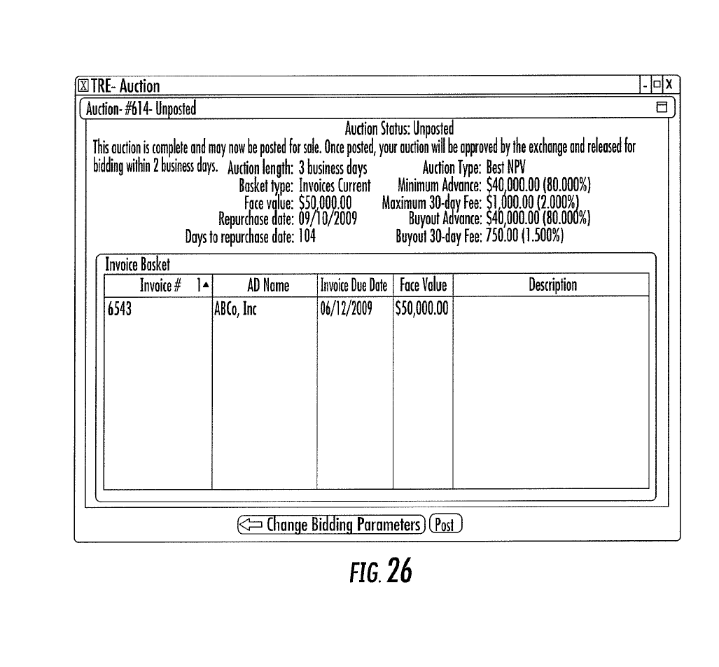

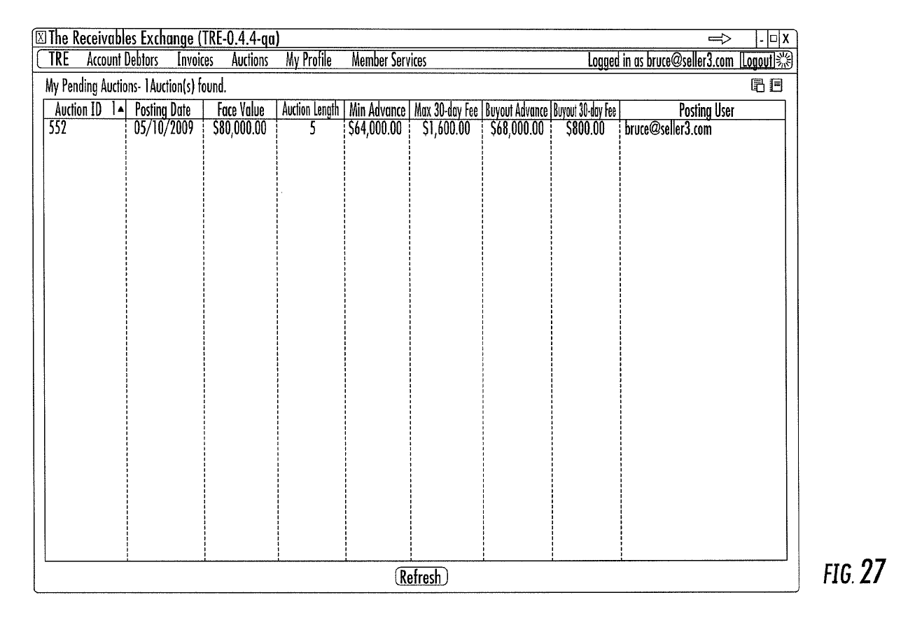

FIG. 26 is a screen diagram illustrating a completed entry for an auction that is ready for posting. Once the seller has reviewed all the information on this screen, they may hit the post button at the bottom. After hitting the post button the auction status will change from un-posted, to pending. A seller can view their pending auctions any time through the system as shown in FIG. 27.

Receivable Verification

Preferably, posted accounts receivable from sellers are verified by the exchange before releasing an auction for bidding. The verification process consists of the following: quantitative verification that the invoice and supporting documentation matches the data that was entered into the exchange application fields; authenticity verification with the debtor on the invoice information. The exchange may verify authenticity internally or through various third party technologies. The exchange may ensure verification quantitative and authenticity verification for all auctions, or a sampling of auctions.

In the event that is unable to verify a particular invoice, the exchange may cancel the pending auction prior to the auction going live and notify the seller of this occurrence.

Buyer's View of Bound Invoice

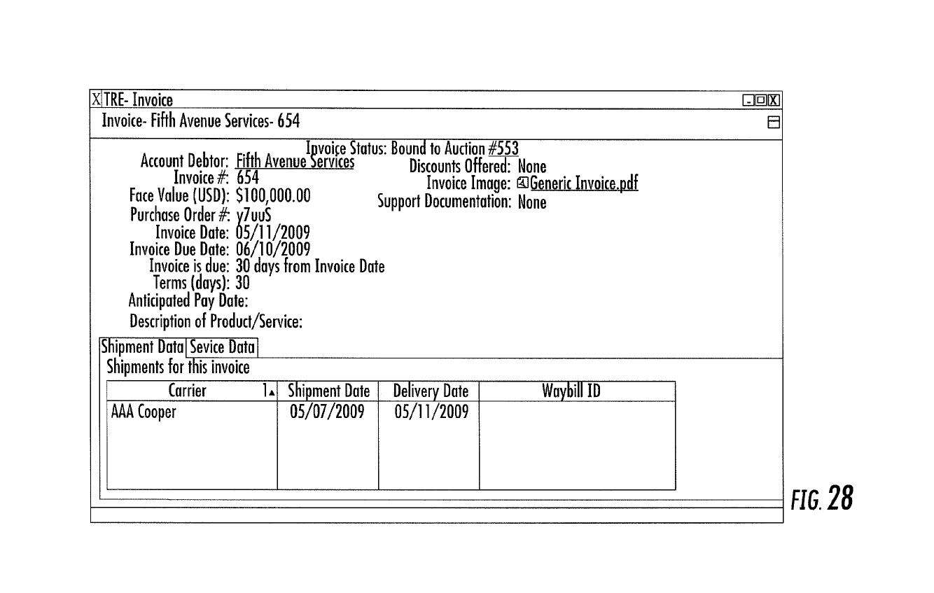

FIG. 28 is a screen diagram illustrating a buyer's view of an invoice bound to a live auction. To facilitate searching the auctions by a buyer, when a seller places an invoice in the system, the system server tags the invoices in its database with a variety of identifiers which might be of interest to buyers. Buyers can then use these tags as search criteria as they parse the exchange for attractive auctions to bid upon.

Step 3: Bidding

The Bidding Process in an Exchange Auction

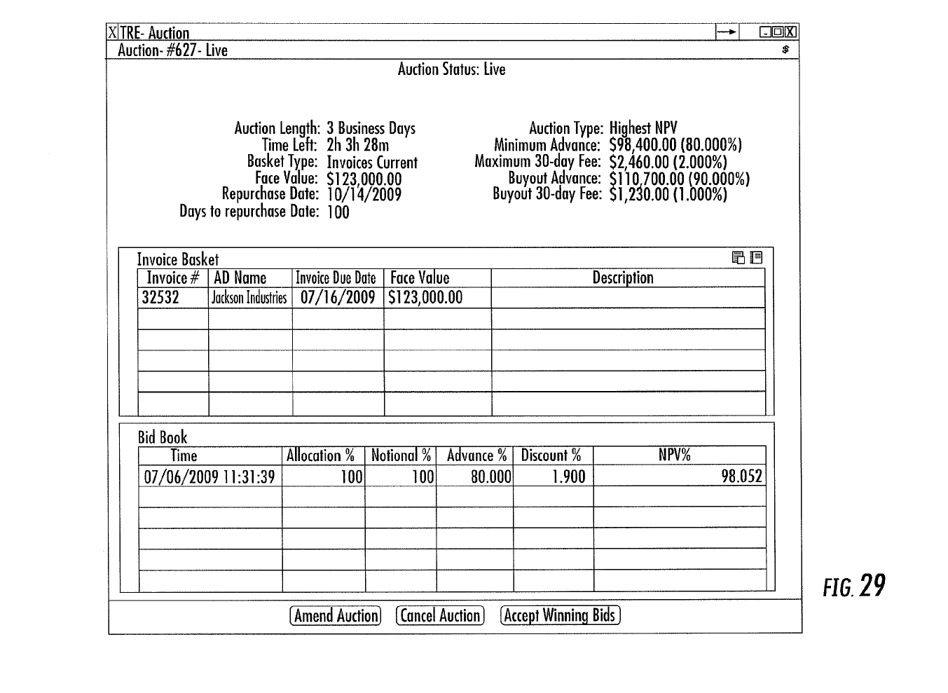

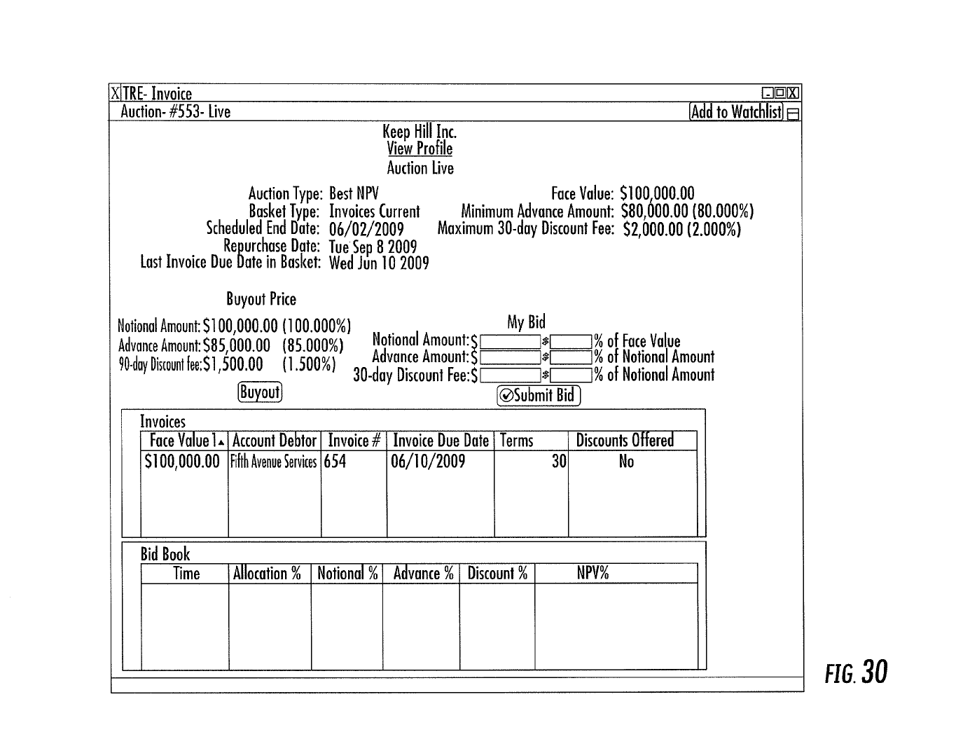

FIGS. 29-30 are screen diagrams illustrating a live auction from a seller and buyer's perspectives respectively. The bidding process is a live process and shows the ranking of all bids that have been submitted and accepted into the system while the auction is open. The system keeps identity of buyers anonymous to the seller and to other buyers. Bidding can be carried out 24 hours a day, seven days a week, with auctions uniformly closing at a specified time (for example, 3 p.m. EST).

Bidding Procedures

A bid consists of three inputs: a Notional Amount: the amount of the auction that the buyer is bidding to purchase (which may be less than 100% of the auction's face value); an Advance Amount: the amount of funds that the buyer is willing to advance to the seller in consideration for the auction purchase; and a 30-Day Discount Fee: the fee the buyer wishes to receive in consideration for purchasing the auction.

Notional Amount: A buyer has the option of bidding to purchase an undivided proportional interest in an auction, which is comprised of a posted accounts receivable or basket of receivables. When a buyer bids to purchase 100% of a posted auction, the Notional Amount is equal to the auction's face value. When a buyer submits a bid to purchase less than 100% participation, the Notional Amount is the percentage amount of the auction's face value that the buyer intends to purchase.

Advance Amount: The Advance Amount is the amount of money the buyer is willing to advance to the seller to purchase the auction.

30-day Discount Fee Amount: The 30-Day Discount Fee is the amount of money a buyer wishes to receive as a fee every 30 days between the auction closing date and the day collection proceeds are received in good funds, or the repurchase date, whichever is the first to occur.

Hitting the “Buyout Price”

All sellers have the option to specify a “Buyout Price” when creating an auction. The Buyout Price is the combination of advance amount and discount fee, which if bid by a single buyer, will result in the instantaneous awarding of the entire auction, thereby closing all further bidding. A buyout bid for an auction is always for 100% of the Notional Amount of the auction. The Buyout Price option will no longer be available once aggregate bids in the bid book exceed the seller's Buyout Price parameters. Buyers can purchase auctions quickly and without entering into the bid book by hitting the buyout button shown on FIG. 30. This will instantly award and close the auction to the winning buyer.

Constraints on Bidding

Preferably, the exchange is configured to restrict the amount or the aggregate amount of bids a single buyer may place or have outstanding on the exchange at any one time.

Reducing the Minimum Advance Amount and Increasing the Maximum Discount Fee

A seller has the option, at any time before an auction ends, to reduce the Minimum Advance Amount or increase the Maximum Discount Fee parameters. The seller may not, however, increase the Minimum Advance Amount or decrease the Maximum Discount Fee from what was previously specified at time of posting. Sellers may also amend their buyout parameters at anytime during a live auction in the same manner. Sellers are obligated to accept bids that are equal to or exceed the Minimum Advance Amount and that are equal to or less than the Maximum Discount Fee as pre-specified by the seller.

Ending an Auction Early Once an auction has enough bids within the seller's parameters to successfully complete the auction, a seller has the option to accept all the winning bids and end the auction before its scheduled close date. If the submitted bids do not meet the seller's parameters, they have the option to accept the best bids in the bid book.

Step 4: Awarding Upon Auction Close

Auctions end on the scheduled auction closing date unless a seller's buyout price is met or an auction is canceled or amended at an earlier time. The seller is able to view the status of an auction at anytime by accessing its account online and viewing the auction. Additionally, if an auction closes successfully, a seller Awarded Auction Report statement will be available for viewing online as of the auction closing date.

Awarding of Exchange Auctions

At the close of an auction, the highest bid meeting or exceeding the seller's criteria is selected and the auction is awarded to the corresponding buyer who becomes the buyer. There may be more than one buyer, and the buyers are allocated their respective percentage of the invoice or basket of invoices in accordance with their ranking in the bid book.

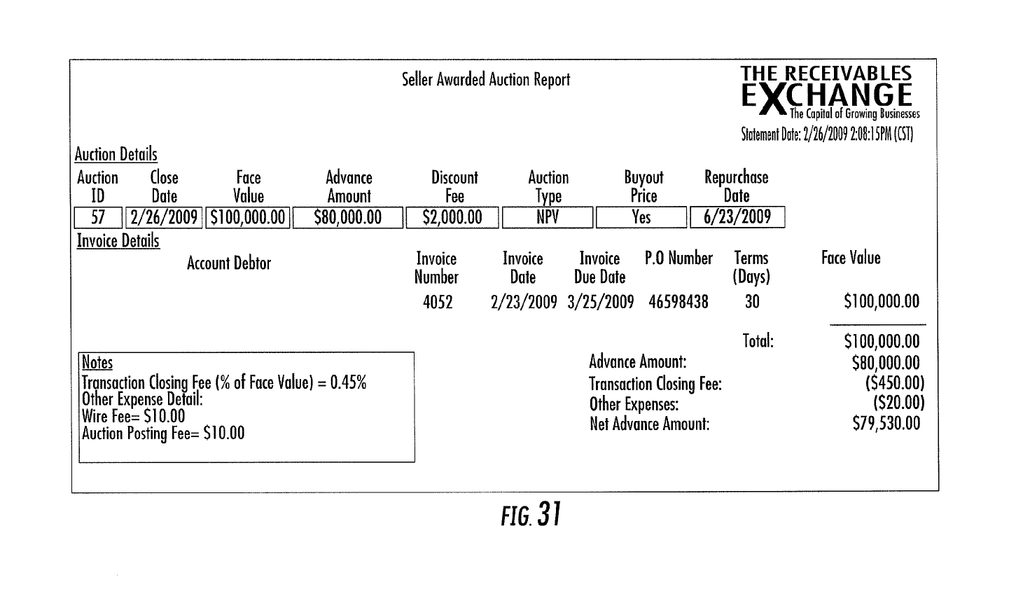

FIG. 31 is a screen diagram illustrating a Seller Awarded Auction Report. Sellers are notified that the auction has closed successfully, and winning buyers are notified of their award. Optionally, the identity of the winning buyers is made known to the sellers.

Step 5: Funding

Funding of Awarded Exchange Auctions

After the winners of the auction are notified, the exchange initiates the appropriate monetary wire transfers so that the seller gets the advance amount from the buyer/buyers through a system clearing account. The exchange initiates a wire transfer from the buyers for the advance amount(s) committed. The buyer wires the advance amount before the start of the next business day. The exchange then wires forward the advance amount, minus any exchange fees, to the seller.

Funding and Payment to the Seller

When an auction successfully closes, the seller will receive payment of the Net Advance Amount from the exchange (after deducting seller transaction fees and applicable wire/ACH fees) on the next business day following the auction closing date. The funds will be transferred into the seller's designated deposit account with the seller's bank via wire transfer.

Step 6: Repayment

Repayment of an Accounts Receivable Transaction

At this point, the system is awaiting remittance of payment from the debtor to a system lockbox via check, ACH or wire transfer. Upon receipt of such remittance, the amount directed to the buyer is calculated as the repayment of the advance amount which is funded plus the accrued discount fees as established by parameters of the winning bid of the auction. Once a buyer has received back their advance plus their accrued discount fee, any funds remaining are remitted back to the seller. At this point the transaction is considered repaid and closed.

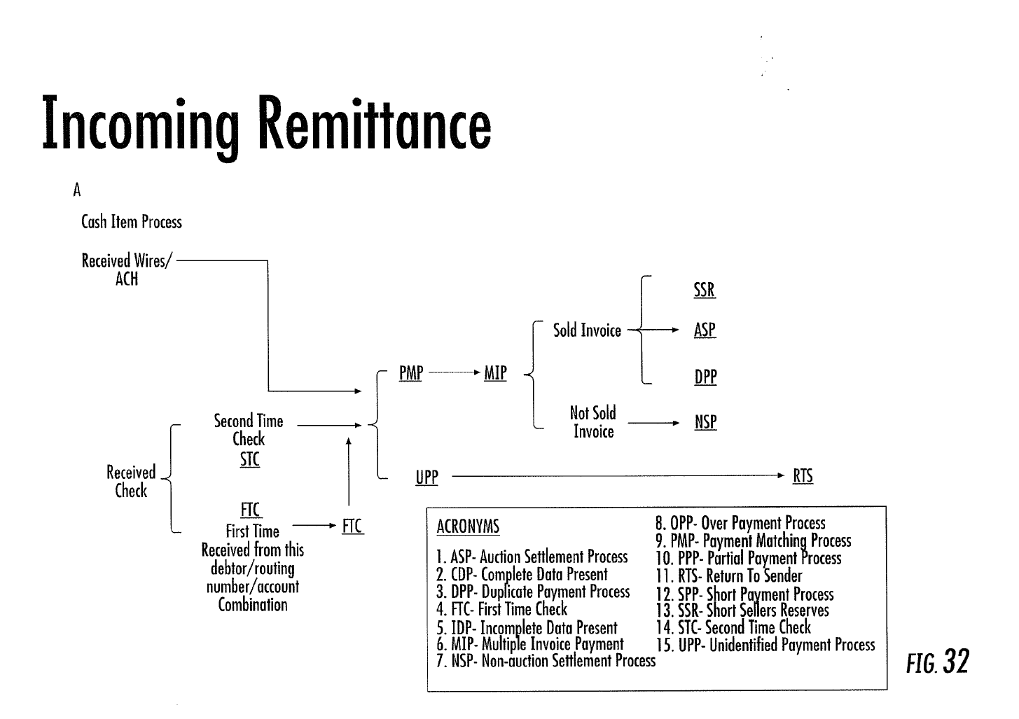

FIG. 32 is a flowchart that illustrates a preferred remittance process. The remittance process preferably comprises several sub-processes, defined below. For example, First Time Check (FTC) is a manual process carried out the first time a check is sent to establish the link between a debtor's records on the system and their account and routing number provided on the check. This process should only need to be done once per debtor, account, routing number combination.

Payment Matching Process (PMP)—At this point the system has a record of the routing number, the account number (therefore identifying the debtor), the payee's company name (seller), and the amount. All wires and ACH payments can be added to the work flow at this point as the details are now the same.

Unidentified Payment Process (UPP)—If there is no match for both debtor and seller on the exchange system, then the received check is reviewed to confirm that it has not been sent to the wrong lockbox, and if there is still no match then the check is returned to the debtor as an unmatched check. If the exchange system does not have information on the seller, then the funds are returned to the debtor with a note stating that the payee is unknown.

Non-Auction Settlement Process (NSP)—If the exchange has records of the seller but not the debtor, the money is sent to the seller with a statement. The exchange will also preferably profile the debtor on the system so that the details of the debtor can be stored and passed to the seller.

Second Time Check (STC)—This process is carried out when checks are received for the second time. When checks are received for the second time, the system identifies the debtor and the bank account that the check is drawn on. With this information, the system then identifies the relationship between the debtor and the seller in a payment matching process.

Multiple Payment Process (MIP)—This is when a remittance with multiple invoices that are being paid is received in one lump sum. The system sorts through each item to identify if the payment is a sold auction item or a non-auction invoice, and allocates the funds accordingly.

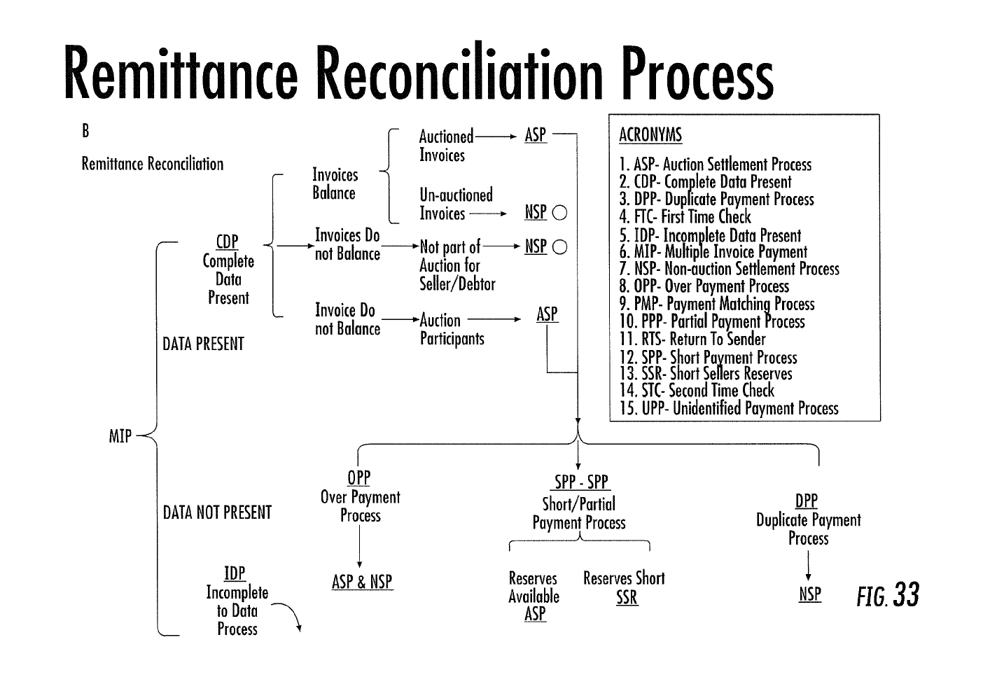

FIG. 33 is a flowchart illustrating the various steps of MIP. First, the exchange obtains information such as the seller name, check amount, debtor name, invoice number(s), date(s) and amount(s).

Over Payment Process (OPP)—Should funds arrive that overpay an invoice (e.g., it is listed as being $5,000 USD and it comes in as $50,000 USD), the auction is settled and the remaining overpayment is sent to the seller in the Auction Settlement Process (ASP) with a notice being sent explaining that the overpayment amount needs to be returned to the debtor. The ASP process enables the system to process each payment without any exceptions or adjustments. The payment amount is reconciled to the invoice amount (either by the Exchange or through a seller reconciliation application).

Short Payment Process (SPP)—Should funds arrive that underpay an invoice (e.g., it is listed as being $5,000 USD and it comes in as $4,000 USD), there are two choices—(1) if the amount is enough to settle the auction it should be treated as completed and settled with the ASP; and (2) if the amount is not sufficient to settle the auction the Short Seller Reserve (SSR) process is started (described in more detail below).

Duplicate Payment Process (DPP)—When funds are received that can be positively identified as duplicative (i.e., they are for an auction that has already been settled), the exchange will forward the duplicate payment will be sent to the seller with a note marking the payment as a duplicate

Incomplete Data Process (IDP)—This process is started depending on the missing piece of data. If the invoice number or debtor information is missing, the system preferably cross-references the amount against all known outstanding invoices in the debtor/seller relationship to see if there is a match. If there is a match, the system uses those funds to settle that auction. If the debtor name is unknown to the exchange and the amount does not match any details on the system, the system establishes a debtor record for future use, and then sends the funds to the seller with a note explaining the situation.

Short Seller Reserve (SSR)—This process is started when the short payment does not cover the advance and fees for the buyer and the exchange. The amount of the payment received is pro-rated to provide all parties involved their respective proportion of the amount paid. It is also preferred that a notice is sent to the seller warning of the short payment and the new repurchase liability should the debtor fail to pay the full amount for that invoice.

Debtor Remittance Payments

All debtor remittance payments with respect to traded accounts receivable are directed and paid into the lockbox account. These payments (collection proceeds) are no longer owned by the seller once a traded receivable is sold over the exchange. The collection proceeds are exclusively owned by the buyer, with the seller having no rights to, or ownership, or control over such collected funds.

Treatment of Staggered Remittance Payments

It is likely that remittance payments from a basket of receivables from multiple debtors will be paid into the lockbox account on different days. If the remittance amount received is not greater than or equal to the sum of the buyer's Advance Amount and accrued discount fees, then the full value of the remittance will be disbursed to the buyer. The remaining advance amount due to the buyer will be adjusted down accordingly, and the daily discount fee rate will be adjusted down as well in proportion to the advance amount paid.

Remittance Exception Procedures

The exchange will use the following procedures when handling remittances to and from the lockbox account:

Duplicate Payments: If the exchange determines that a duplicate payment was made with respect to a traded receivable, the duplicate payment amount will be sent to the seller with a follow-up notification that the remittance has been flagged as a duplicate payment. The seller has sole responsibility to return/reconcile duplicate payment amounts to/with the debtor.

Credit Adjustments: Upon the exchange's determination that the debtor has applied a credit to a seller's traded receivable, the seller wires the amount of the credit adjustment to the lockbox account. Alternatively, the seller may elect to apply any amounts that may be due to the seller against the adjusted amount.

Unknown Seller: If the exchange is unable to identify the payee of a check or draft as a registered seller for a given debtor remittance, the payment will be returned to the debtor.

Remittances with No Receivable Identification Detail: The exchange will notify the seller to reconcile debtor payments to the correct receivable.

Returned Checks: The exchange will notify the seller if, for any reason, a debtor's check or draft is returned unpaid by the debtor's bank. If the check was intended to pay a traded receivable, the seller then wires the amount of the intended payment amount into the lockbox account within a certain amount of time (i.e., 1 business day). The exchange is also preferably configured such that the seller is responsible for any additional fees accrued by the buyer or incurred by the exchange due to returned items.

Misapplied Payments: If the exchange determines that there has been a payment error due to a debtor, seller, or buyer, or if the exchange has committed an administrative error, the exchange will immediately request all parties involved to remedy the error. Any request to offset a previous transaction will be communicated to the buyer or seller at least 1 business day in advance.

Notification of Disputes: Should a debtor dispute payment for any reason, the seller is obligated to immediately repurchase a traded receivable from the buyer. Any request resulting from a disputed payment will be communicated to the seller or the buyer at least I business day prior to repurchase.

Overpayment by Debtor: the exchange will forward debtor overpayment amounts to the seller (less the exchange's administrative service fee). The seller has sole responsibility to return/reconcile overpayment amounts to/with the debtor.

Seller Remittance Payments

The system is preferably configured to provide the seller a portion of the retained amount (that is, the un-advanced portion of the accounts receivable face value) in the form of a seller remittance payment. The system is further configured to prevent a seller from applying a seller remittance payment to pay down the advance amount or accrued discount fees with respect to a separate auction. The exchange will determine the amount of the seller remittance payment by subtracting (i) the amount of discount fees earned by the seller on a daily basis through the date when the debtor's remittance is received in good funds, from (ii) the retained amount.

Step 7: Settlement

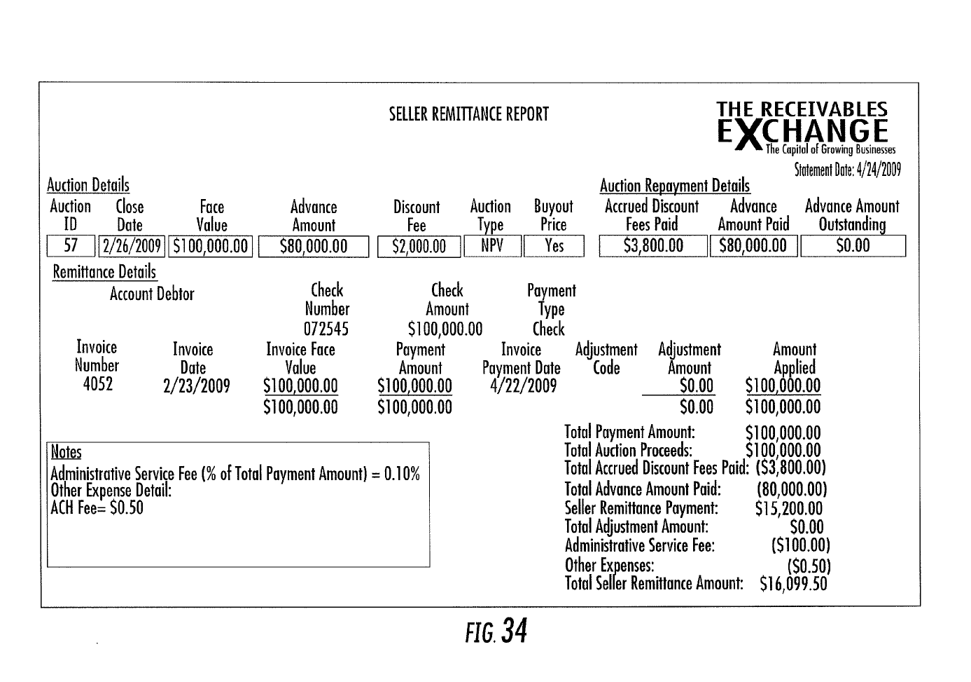

FIG. 34 is a screen diagram illustrating a completed transaction and seller remittance report. Once the buyer and seller have been repaid, the transaction is complete and is considered settled. The accounts receivable transaction is now closed.

Reports and Reconciliations

The exchange will provide the seller with reports and reconciliation statements designed to permit the seller to reconcile and have a record of all inbound and outbound payment flows between the seller and the exchange. These reports will be made available on an individual transaction basis, and also on an aggregate basis at the end of each calendar year. Such reports and statements will detail all seller transactional history including the exchange's fees and expenses.

The Secondary Market

In the secondary market, buyers can act as sellers and resell the invoices they have won at auction to another buyer. Preferably, this is accomplished in a similar manner that listing, bidding, awarding, funding, repayment and settlement occur in the primary market.

Although the present invention has been described in relation to an auction for an accounts receivable invoice, the present invention can also be used to monetize a variety of balance sheet and financial assets, such as, for example, equipment loans and leases, inventory financing, purchase order finance, trade credit and supply chain financing. Any financial asset that can be utilized as collateral in a manner that facilitates financing could be standardized and traded on primary and secondary markets in the same fashion that accounts receivable have been described herein. We claim:

1. A computerized method of conducting an auction of one or more financial assets by an electronic exchange system, the computerized method comprising:
establishing an account to receive payment from an obligor associated with the one or more financial assets, the account being accessible by the electronic exchange system;
receiving information associated with the obligor of the one or more financial assets;
receiving information on the one or more financial assets held by a seller;
verifying validity and accuracy of the information associated with the one or more financial assets;
the electronic exchange system offering the one or more financial assets for sale in an auction, along with access to the received information;
accepting bids from one or more buyers for the one or more financial assets during the auction;
awarding the auction to the one or more buyers based on the bids; and
electronically settling payment for purchase of the auction.

2. The method of claim 1, further comprising registering the seller and the one or more buyers before conducting the auction.

3. The method of claim 2, wherein registering the seller comprises collecting seller information comprising at least one of articles of incorporation, bylaws, bank statements, tax statements, financial statements and third party background information on the seller.

4. The method of claim 2, wherein registering the one or more buyers comprises collecting buyer information comprising at least one of articles of incorporation and accreditation confirmation.

5. The method of claim 1, wherein a lien is filed on the one or more financial assets of the seller.

6. The method of claim 1, wherein the information associated with the obligor comprises at least one of identifying information, previous payment history and contact information.

7. The method of claim 1, further comprising receiving financial asset information comprising at least one of a digital image of the one or more financial assets, associated and documented calendar dates, identifying numbers, amounts, shipping or service information and payment terms.

8. The method of claim 1, wherein the one or more financial assets are bound into the auction which is salable on the exchange system.

9. The method of claim 8, wherein the process of binding the one or more financial assets into the auction involves receiving at least one of auction length, financial basket type and pricing parameters.

10. The method of claim 1, wherein a repurchase date is assigned to the auction.

11. The method of claim 1, wherein the award is made based on a best overall price bid received before closing the auction.

12. The method of claim 1, wherein the award is made based on a lowest-fee based bid received before closing the auction.

13. The method of claim 1, wherein the award is made based on a highest advance rate bid received before closing the auction.

14. The method of claim 1, further comprising receiving information from the seller comprising a basis for awarding bids.

15. The method of claim 1, further comprising electronically settling remittance for the one or more financial assets.

16. The method of claim 1, wherein the obligor is not notified that the one or more financial assets are being auctioned by the seller.

17. The method of claim 1, wherein the buyer's identity is not revealed to the seller.

18. The method of claim 1, wherein the buyer's identity is not revealed to the obligor.

19. The method of claim 1, wherein the one or more financial assets are traded in a secondary market.

20. An electronic exchange system for auctioning one or more financial assets, the exchange system comprising:
a data communications network; and
one or more computers coupled to the data communications network, each computer having a processor, memory and program code stored on computer-readable medium that, when said code is loaded into the memory and run by the processor, causes the electronic exchange system to perform the steps of:
establishing an account to receive payment from an obligor associated with the one or more financial assets, the account being accessible by the electronic exchange system;
receiving information associated with the obligor of the one or more financial assets;
receiving information on one or more financial assets held by the seller;
verifying validity and accuracy of the information associated with the one or more financial assets;
the electronic exchange system offering the one or more financial assets for sale in an auction, along with access to the received information;
accepting bids from one or more buyers for the one or more financial assets during the auction;
awarding the auction to the one or more buyers based on the bids; and
electronically settling payment for purchase of the auction.

21. The electronic exchange system of claim 20, wherein the program code causes the electronic exchange system to further perform the step of registering the seller and the one or more buyers before conducting the auction.

22. The electronic exchange system of claim 21, wherein registering the seller comprises collecting seller information comprising at least one of articles of incorporation, bylaws, bank statements, tax statements, financial statements and third party background information on the seller.

23. The electronic exchange system of claim 21, wherein registering the one or more buyers comprises collecting information comprising at least one of articles of incorporation and accreditation confirmation.

24. The electronic exchange system of claim 20, wherein the program code causes the system to file a lien on the one or more financial assets of the seller.

25. The electronic exchange system of claim 20, wherein the information associated with the obligor comprises at least one of identifying information, previous payment history and contact information.

26. The electronic exchange system of claim 20, further comprising receiving financial asset information comprising at least one of a digital image of the one or more financial assets, associated and documented calendar dates, identifying numbers, amounts, shipping or service information and payment terms.

27. The electronic exchange system of claim 20, wherein the one or more financial assets are bound into the auction which is salable on the exchange system.

28. The electronic exchange system of claim 27, wherein the process of binding the one or more financial assets into the auction involves receiving at least one of auction length, financial basket type and pricing parameters.

29. The electronic exchange system of claim 20, wherein the program code causes the electronic exchange system to further perform the step of assigning a repurchase date to the auction.

30. The electronic exchange system of claim 20, wherein the award is made based on a best overall price bid received before closing the auction.

31. The electronic exchange system of claim 20, wherein the award is made based on a lowest-fee based bid received before closing the auction.

32. The electronic exchange system of claim 20, wherein the award is made based on a highest advance rate bid received before closing the auction.

33. The electronic exchange system of claim 20, wherein the program code causes the electronic exchange system to receive information from the seller comprising a basis for awarding bids.

34. The electronic exchange system of claim 20, wherein the program code causes the electronic exchange system to electronically settle remittance for the invoice.

35. The electronic exchange system of claim 20, wherein the debtor is not notified that the one or more financial assets are being auctioned by the seller.

36. The electronic exchange system of claim 20, wherein the buyer's identity is not revealed to the seller.

37. The electronic exchange system of claim 20, wherein the buyer's identity is not revealed to the obligor.

38. The electronic exchange system of claim 20, wherein the one or more financial assets are traded in a secondary market.
